(19) United States
(12) Patent Application Publication
(10) Pub. No.: US 2025/0377775 A1
(43) Pub. Date: Dec. 11, 2025

(54) USER INTERFACES FOR MEDIA MANAGEMENT

(71) Applicant: Lemon Inc., Grand Caymon (KY)

(72) Inventors: Linlin Chen, Culver City, CA (US); Tianhao He, Culver City, CA (US)

(21) Appl. No.: 18/736,893

(22) Filed: Jun. 7, 2024

(51) Int. Cl. G06F 3/0485; G06F 3/04817; G06F 3/04883

(52) U.S. Cl. CPC G06F 3/0485; G06F 3/04817; G06F 3/04883

(57) ABSTRACT

User interfaces (UIs) for media management and methods for controlling UIs are described. In one example, an electronic device receives an instruction to invoke a media editing functionality of an application. In response to receiving the instruction, the electronic device renders a UI of the application on the electronic device, where the UI includes a first image and an image sliding bar, the image sliding bar comprises a plurality of selected images, and the plurality of selected images respectively correspond to a plurality of images stored in a media library accessible by the application. A first user interaction with the UI is received, and the image sliding bar is hidden in response to the first user interaction. A second user interaction with the UI is received, and the image sliding bar is displayed in response to the second user interaction.

### TECHNICAL FIELD

The present disclosure generally relates to user interfaces, and more specifically, to user interfaces for media management.

### BACKGROUND

A user interface (UI) for media management systems can designed to handle various forms of media such as images, videos, audio files, and other digital content in an efficient and user-friendly manner. The design and complexity of the UI can vary significantly depending on the purpose of the device and the tasks it is designed to perform.

### SUMMARY

The present disclosure describes user interfaces for media management.

In one aspect, the present disclosure describes a method. The method includes the following operations: in response to receiving an instruction to invoke a media editing functionality of an application, rendering, by an electronic device, a user interface of the application on the electronic device, wherein the user interface comprises a first image and an image sliding bar, wherein the image sliding bar comprises a plurality of selected images, and wherein the plurality of selected images respectively correspond to a plurality of images stored in a media library accessible by the application; receiving a first user interaction with the user interface; in response to the first user interaction, hiding the image sliding bar; receiving a second user interaction with the user interface; and in response to the second user interaction, displaying the image sliding bar.

Particular implementations may include one or more of the following features.

In some implementations, the user interface further comprises an icon of a first interactive element, and the icon of the first interactive element is switchable between a first icon and a second icon based on user interactions with the first interactive element.

In some implementations, the first user interaction comprises a swipe-down gesture on the user interface or a tap on the first icon of the first interactive element.

In some implementations, the method further includes: in response to the first user interaction, switching the first icon of the first interactive element to the second icon of the first interactive element.

In some implementations, the second user interaction comprises a swipe-up gesture on the user interface or a tap on the second icon of the first interactive element.

In some implementations, the method further includes: in response to the second user interaction, switching the second icon of the first interactive element to the first icon of the first interactive element.

In some implementations, the method further includes: after hiding the image sliding bar and in response to detecting no user interaction with the user interface for a time period, displaying a second user interactive element on the user interface, wherein the second user interactive element comprise a carousel indicator.

In some implementations, the method further includes: receiving a third user interaction with the user interface, wherein the third user interaction comprises a swipe-up gesture or a tap on the second user interactive element; and in response to the third user interaction, displaying the image sliding bar.

In some implementations, the image sliding bar further comprises a third interactive element for accessing the media library accessible by the application, and the method comprises: receiving a fourth user interaction with the third interactive element; in response to receiving the fourth user interaction with the third interactive element, displaying the media library.

In some implementations, the method further includes: receiving a fifth user interaction with a particular image of the plurality of selected images in the image sliding bar, wherein the fifth user interaction with the particular image comprises pressing the particular image for a duration longer than a threshold. In response to the fifth user interaction with the particular image, a deletion icon is displayed in a space of the user interface other than a space occupied by the image sliding bar. The fifth user interaction further includes moving the particular image to a particular location on the user interface within the space of the user interface other than the space occupied by the image sliding bar, and releasing the particular image at the particular location. In response to the releasing, the particular image is removed from the image sliding bar.

In some implementations, the space of the user interface other than the space occupied by the image sliding bar include an area under the image sliding bar.

In some implementations, the method further includes: receiving a sixth user interaction with a particular image of the plurality of selected images in the image sliding bar, wherein the sixth user interaction with the particular image comprises: moving, while pressing on the particular image, the particular image to another location in the image sliding bar; and releasing the particular image at the another location; and in response to the sixth user interaction with the particular image, rearranging a display order of the plurality of selected images in the image sliding bar and displaying the particular image in a location between two images of the plurality of selected images that are nearest to the another location.

In some implementations, the method further includes: in response to receiving an instruction to invoke a post publishing functionality of the application, rendering, by the electronic device, another user interface of the application on the electronic device, wherein the another user interface comprises icons representing multiple preview modes, and the multiple preview modes comprises a feed mode and a full post mode; receiving a selection of the full post mode; in response to the selection of the full post mode, concurrently displaying a particular image and a window comprising text content in the full post mode; receiving a seventh user interaction with the window comprising the text content in the full post mode; and in response to the seventh user interaction with the window comprising the text content in the full post mode, providing an expanded window to show an expanded view of the text content.

In another aspect, the present disclosure describes an apparatus including one or more processors and one or more computer-readable memories coupled to the one or more processors. The one or more computer-readable memories store instructions that are executable by the one or more processors to perform the above-described operations.

In still another aspect, the present disclosure describes a non-transitory computer-readable storage medium. The non-transitory computer-readable storage medium stores programing instructions executable by one or more processors to perform the above-described operations.

The details of one or more implementations of the subject matter of this disclosure are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1D illustrate an example UI for media management, according to one or more implementations of the disclosure.

FIGS. 2A-2D illustrate an example UI for media management, according to one or more implementations of the disclosure.

FIGS. 3A-3F illustrate an example UI for media management, according to one or more implementations of the disclosure.

FIGS. 4A-4C illustrate an example UI for media management, according to one or more implementations of the disclosure.

FIGS. 5A-5D illustrate an example UI for media management, according to one or more implementations of the disclosure.

FIGS. 6A-6D illustrate an example UI for media management, according to one or more implementations of the disclosure.

FIGS. 7A-7E illustrate an example UI for media management, according to one or more implementations of the disclosure.

FIGS. 8A-8D illustrate an example UI for media management, according to one or more implementations of the disclosure.

FIGS. 9A-9C illustrate an example UI for media management, according to one or more implementations of the disclosure.

FIGS. 10A-10D illustrate example UIs for media management, according to one or more implementations of the disclosure.

FIGS. 11A-11D illustrate an example UI for media management, according to one or more implementations of the disclosure.

FIGS. 12A and 12B illustrate an example UI for media management, according to one or more implementations of the disclosure.

FIG. 13 illustrates an example UI for media management, according to one or more implementations of the disclosure.

FIGS. 14A and 14B illustrate an example UI for media management, according to one or more implementations of the disclosure.

FIG. 15 illustrates an example UI for media management, according to one or more implementations of the disclosure.

FIGS. 16A-16D illustrate an example UI for media management, according to one or more implementations of the disclosure.

FIG. 17 illustrates an example UI for media management, according to one or more implementations of the disclosure.

FIG. 18 illustrates an example UI for media management, according to one or more implementations of the disclosure.

FIG. 19 illustrates a block diagram of an example process of controlling a UI for media management, according to one or more implementations of the disclosure.

FIG. 20 illustrates a block diagram of an example computer system, according to one or more implementations of the disclosure.

Like reference numbers and designations in the various drawings indicate like elements.

### DETAILED DESCRIPTION

A user interface (UI) on an electronic device is the space where interactions between humans and machines occur. One goal of an effective UI is to make the user's experience as intuitive and efficient as possible. In the context of electronic devices, such as smart phones, pads, tablets, TVs, or other computer devices or terminals, a UI can include everything from the layout of the screen, the design of the buttons and icons, to the responsiveness of the electronic device when a user interacts with it. For an electronic device that includes a display or screen such as a touchscreen, the UI can include a graphical user interface (GUI). In some implementations, the user interacts with the GUI, for example, through finger contacts and/or gestures on or in front of the touchscreen.

Example techniques for providing effective UIs for media management are described. In some implementations, media management can include, for example, creating, editing, adding, deleting, displaying/presenting, storing, transmitting/receiving, or otherwise handling one or more types of digital content such as texts, images, videos, and audio files. The UIs for media management can be included or provided in one or more applications/programs of the electronic device. For example, the applications/programs can include one or more of a social networking application, a photo/video posting/sharing application, a web-browsing application, or integrate functionalities of one or more of these and other applications/programs. An example application can be a video sharing application that allows a user to create content, for example, by uploading and editing media such as text, image, video, and/or audio, and sharing the created content publicly or within one or more groups, for example, in the form of a post. A post can include any digital interface or section within a digital platform that presents user-generated digital content to viewers, which includes, but is not limited to, static digital posts, dynamic feeds, short-form video segments, serialized story components, multimedia reels, and live streaming sessions. Each format of a post can contain text, images, video, audio, or any combination thereof, and can be designed for user interaction such as viewing, commenting, sharing, or participating. The content can be curated algorithmically or user-directed, providing a personalized experience based on viewer preferences and interaction history. The application can also include social networking features or services that allow other users to interact with the user who uploads or create the post.

The described techniques provide example UIs that are intuitive and use friendly, providing easy navigation, effective organization through, for example, folders, tags, and searchable metadata, and quick access via thumbnails and previews. The described techniques incorporate into the UI features such as batch processing capabilities for applying actions to multiple files simultaneously, tools for editing and managing metadata, and robust security measures to protect sensitive media. Additionally, the described techniques provide improved accessibility and responsiveness, suitable for users of various skill levels and adaptable to different devices. The described techniques allow integration with other systems like content management or digital asset management systems, for example, for professional environments, enhancing the overall workflow. The described techniques can also provide customization options that allow users to tailor the interface to their specific needs and workflows, further enhancing productivity and user satisfaction in managing media collections.

The described techniques can help solve or address challenges encountered by current UI implementations for managing media. For example, the described techniques can improve efficiency in user workflow, for example, by provide more efficient UI design such that users do not need to navigate back to the upload page to add, delete, or reorder photos. In some implementations, in this way, the described techniques reduce toggling between pages to finalize content, improve efficiency and system responsiveness, improve user experience, and afford users more interactive capabilities, such as the ability to manipulate photos directly through dragging or sliding on the post page.

The described techniques provide a method for users to preview the full page of a post on the post page before publishing, by tapping the textual content, such as captions, associated with a photo. This allows for a seamless transition to preview the post, minimizing interruptions and aligning well with user consumption behaviors. These features can also enhance the media management experience by being seamlessly integrated and minimally intrusive, thus conserving screen real estate and simplifying the user interface. These features can aid in crafting a multifunctional space that is user-friendly and efficient without overwhelming the interface.

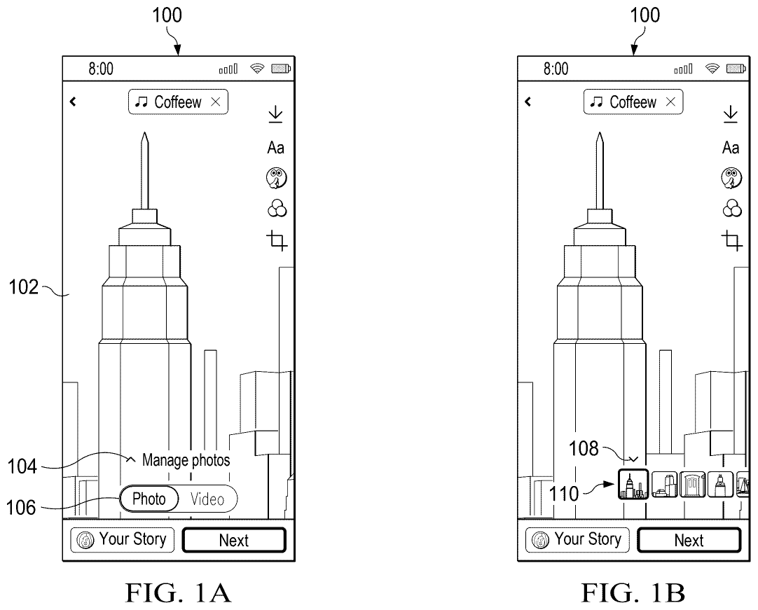

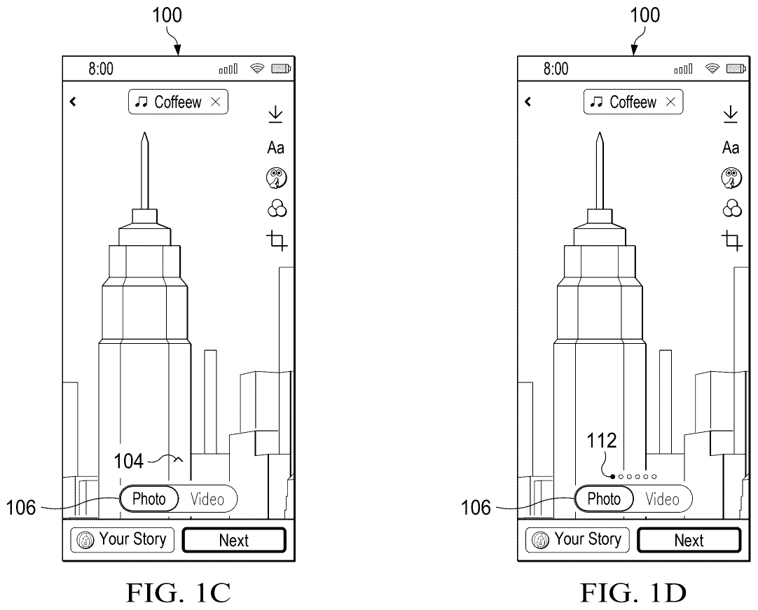

FIGS. 1A-1D illustrate an example UI 100 for media management, according to one or more implementations of the disclosure. In some implementations, UI 100 is rendered on an electronic device in response to an instruction to invoke a media editing functionality of an application (e.g., a mobile or web-based app) installed on the electronic device (e.g., a smartphone or desktop computer). The application can be, for example, a video sharing application as described above. In some implementations, the instruction to invoke the media editing functionality is received after the user selects or enters one or more media content for creating a post. For example, the instruction to invoke the media editing functionality can be a user interaction with an explicit icon indicating editing functionality (e.g., an icon labeled as “Edit”) shown on a post creating page, or an implicit icon indicating the completion of the selection or entry of the media content for creating a post (e.g., an icon labeled as “Next” or “Confirm” in an image/video selection page).

In some examples, as shown in FIG. 1A, UI 100 includes a media editing page of UI 100 rendered on the electronic device, in response to the instruction to invoke the media editing functionality. As shown, UI 100 include an image 102, an icon 104 and a “manage photo” label adjacent to icon 104 to show that an interaction with icon 104 would invoke photo management function of phone/videos that has been selected/entered, and a media access control element 106 to control the accessibility to a photo library and/or a video library.

In some implementations, the “manage photo” label is an example textual label used to serve instructional purposes, guiding users on how to interact with the media management tools offered by the UI. In some implementations, particularly tailored for first-time users, the “manage photo” label remains persistently visible when accessing the media editing page. This design can help guide new users through the media management process, enhancing their initial interaction with the application. For returning users, the “manage photo” label can be configured to be hidden by default, promoting a cleaner and more streamlined interface. This adaptive visibility of interface elements based on user familiarity can offer a customized experience, providing ease of use and interface efficiency.

Media access control element 106, which facilitates user access to various media repositories, such as a photo library and a video library, allows users to seamlessly browse and select media files for editing or posting, enhancing the interface's overall utility and user-friendliness.

In some examples, one or more interactions with UI 100, such as tapping on icon 104 or performing a swipe-up gesture on the device's display activate certain dynamic changes within the interface. As shown in FIG. 1B, one or more of these interactions can trigger the display of image bar 110, transition icon 104 to icon 108, and cause media access control element 106 to be concealed within UI 100.

Icons 104 and 108 serve as interactive elements within UI 100, designed to switch between these two states depending on the user's interactions. In the provided examples, icon 104 is represented as an upward arrow, suggesting an action to reveal or expand additional options, whereas icon 108 is depicted as a downward arrow, indicating a closure or retraction of the interface element. These icons, while exemplified here as arrows, could be implemented using any suitable symbols that clearly communicate the interactive toggle functionality to the user.

This design can enable a fluid and intuitive interaction experience, allowing users to navigate through the interface options and manage their media with less effort. In some implementations, the switchable icon functionality not only enhances the aesthetic appeal of the UI but also improves its usability, making it straightforward for users to understand and execute the required actions for managing their media content effectively.

In the shown examples, image bar 110 is composed of a collection of selected images. Each of these selected images within image bar 110 corresponds to images or videos stored in a media library, which is accessible by the application. Although image bar 110 is shown to include solely images, in some examples, image bar 110 can represent one or more video clips or other formats of media. For example, an image in the image bar 110 can be a first or another frame of a video, and thus represent the video that is selected by the user to be included in a post. In some implementations, image bar 110 severs as an editing queue that includes all currently selected images to be uploaded in a post. As shown, one notable feature is that an image in image bar 110 that is positioned in alignment with icon 108 (e.g., directly underneath or pointed by icon 108) is displayed as a reduced version, such as a thumbnail, of image 102. In some implementations, this particular image can be distinguished by its relatively larger size or having a distinguishing outline compared to the other images displayed within image bar 110, indicates image 102 is the image subject to editing, among the selected images. In some implementations, the image 102 can be another image other than the first image (e.g., a second, a third, etc.) in image bar 110. This configuration facilitates a more organized and visually intuitive user interaction by allowing users to quickly identify and access major images directly from image bar. The use of thumbnails can help conserve screen space while providing a quick reference to the content, enhancing the user's ability to navigate through their media selection efficiently. The larger size of the main image in proximity to icon 108 can emphasize its significance or status as a primary selection, aiding users in their editing or posting workflows.

In some examples, user interactions such as tapping on icon 108 or swiping on the display of UI 100 initiate a series of interface adjustments or updates. As shown in FIG. 1C, either of these actions can result in the concealment of image bar 110, a switch from icon 108 back to icon 104, and the re-appearance of the media access control element 106 within UI 100. This functionality can enhance the UI 100's dynamic response to user inputs, allowing for a fluid transition between different states of the interface based on user needs and actions. The reversible icon feature between icons 104 and 108 provides a clear visual cue to users about the current state of UI 100 and available actions. Re-hiding image bar 110 and revealing media access control element 106 can streamline the interface, returning it to its initial state and readying it for further user interactions. This design can improve the use of screen space and maintain UI 100's simplicity and ease of use.

In some examples, as shown in FIG. 1D, when the electronic device does not detect any user interaction for at least a predetermined period of time, such as 800 milliseconds, following the concealment of image bar 110, indicator 112, such as a carousel indicator including a set of scrolling elements to help users navigate between different pieces of content, can be activated and displayed in the position originally occupied by icon 104 on UI 100. This functionality can enhance the user interface by employing a timeout feature that triggers a visual notification in the form of a carousel indicator. The appearance of indicator 112 in place of icon 104 after a period of user inactivity can serve to visually prompt users about available navigational options within the carousel.

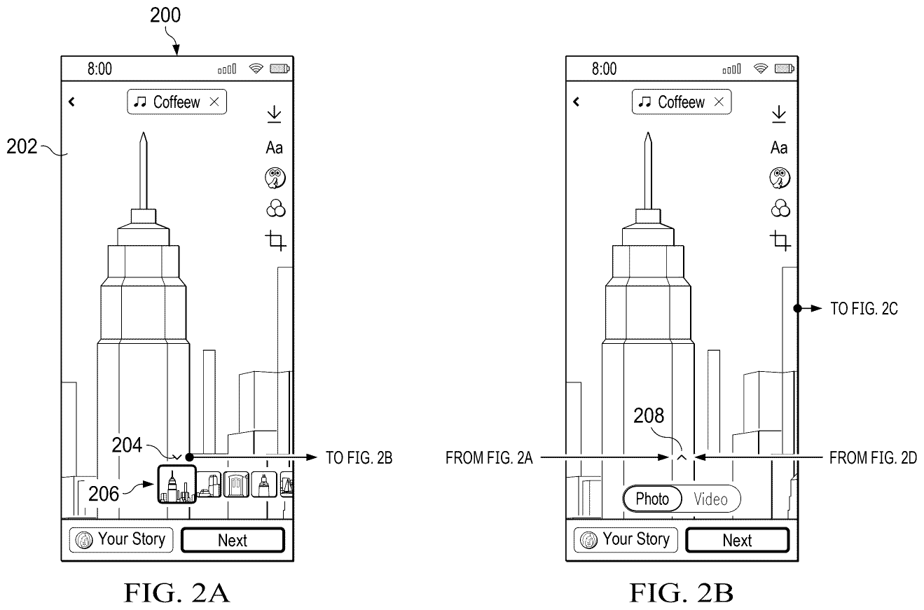

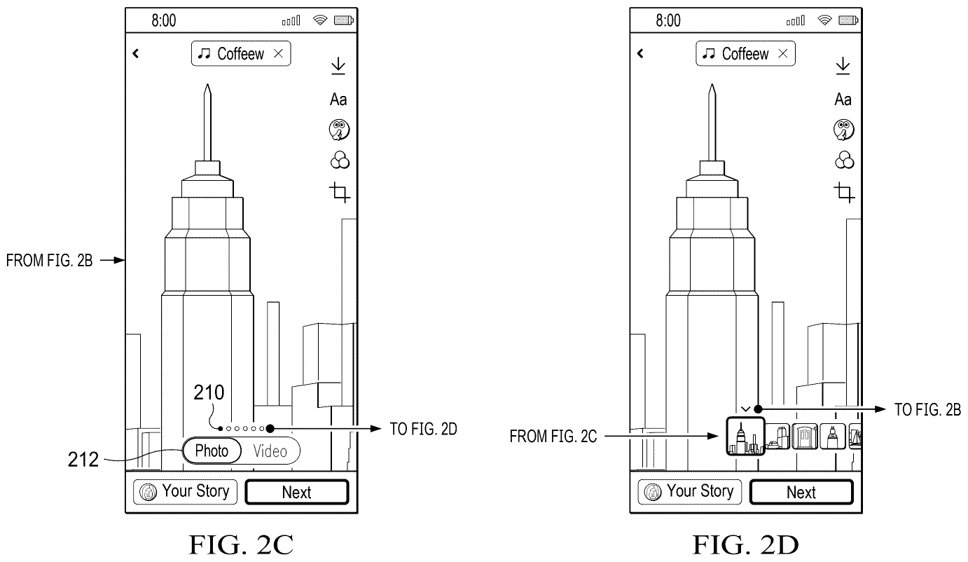

FIGS. 2A-2D illustrate an example UI 200 for media management, according to one or more implementations of the disclosure. For the purposes of brevity and clarity, the description of elements in FIGS. 2A-2D that are similar or identical to those found in previous Figures will not be repeated. In some implementations, UI 200 is integrated with functionalities that allow user to hide or unhide an image bar, designed to support editing tasks. This capability can facilitate a streamlined user experience by enabling users to dynamically adjust the visibility of the image bar based on their specific editing needs. Such functionality can enhance the interface's versatility, allowing for an uncluttered workspace when the image bar is not in use, and quick access to editing tools when needed, thereby improving efficiency and user interaction within the application.

In some implementations, a media editing page of UI 200 is rendered on an electronic device as a result of activating the editing function of an application installed on the device. As shown in FIG. 2A, UI 200 includes elements such as image 202, icon 204, and image bar 206. These components can facilitate user interaction and enhance the editing capabilities offered by the application.

Interacting with UI 200, for example, either by tapping on icon 204 or executing a swipe-down gesture on the device's display, can initiate dynamic modifications within the interface. As shown in FIG. 2B, either of such interactions can cause a transformation of icon 204 to icon 208, trigger the display of media access control element 212, and result in the concealment of image bar 206.

Furthermore, as shown in FIG. 2C, if there is no user interaction with UI 200 is detected by the electronic device for at least a specified duration, such as 800 milliseconds, following the concealment of image bar 206, a carousel indicator designated as indicator 210 can be activated. This indicator takes the place of icon 208 on UI 200.

Subsequent user actions, such as tapping on indicator 210 or performing a swipe-up gesture on the display of UI 200, facilitate the return of image bar 206 and icon 204, while simultaneously causing the media access control element 212 to be hidden, as shown in FIG. 2D. These responsive actions within UI 200 can ensure that users can efficiently navigate and manage their media directly through interface elements.

The responsive nature of UI 200 can enhance its usability and accessibility. The intuitive design of the interactions can allow for seamless transitions between viewing and managing media, promoting a fluid and user-friendly experience.

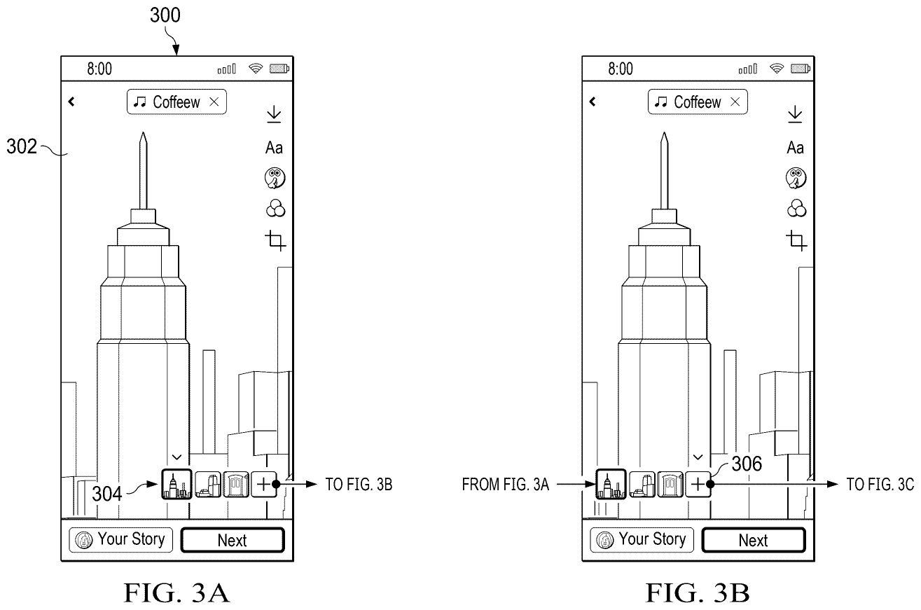

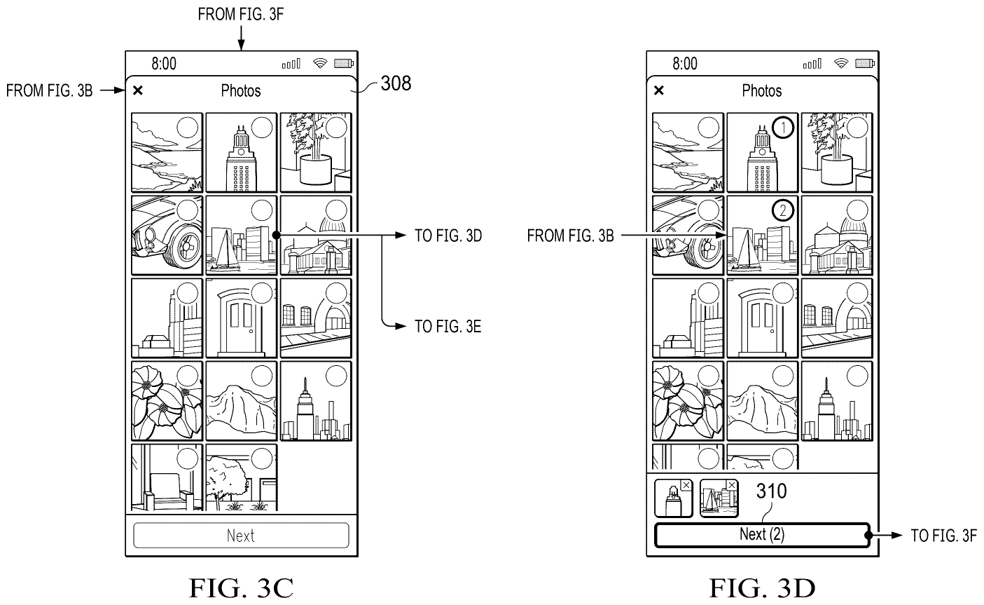

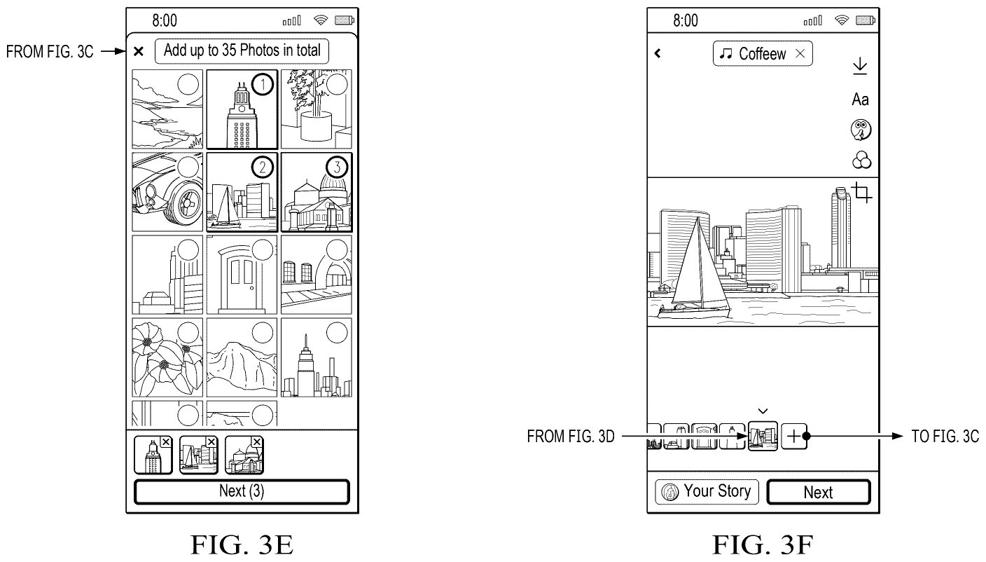

FIGS. 3A-3F illustrate an example UI 300 for media management, according to one or more implementations of the disclosure. In some implementations, UI 300 is integrated with functionalities that enable users to add one or more images for a post, allowing users to seamlessly incorporate and modify images within the same interface framework. This integration can support a streamlined workflow, facilitating both the addition and subsequent editing of images, thereby improving user efficiency and interaction with the user interface.

As shown in FIG. 3A, a media editing page of UI 300 includes image 302 and image bar 304. The image bar is, for example, positioned at the bottom portion of UI 300. Image bar 304 is designed to display a series of image thumbnails and features an icon 306 represented, for example, by a plus sign to facilitate the addition of new images. Users can initiate the image addition process by tapping on icon 306, which triggers the transition to adding page 308, as shown in FIGS. 3B and 3C. The adding page 308 can show images in the media library accessible by the application. The user can select images shown in the adding page 308 to add more images for a post. The adding page 308 provides a user-friendly mechanism for integrating additional images into the existing collection. During this process, to enhance user experience, background music may continue to play, maintaining a pleasant user environment. In some implementations, images that were previously added do not appear on adding page 308, simplifying the selection process and avoiding redundancy. In some implementations, adding page 308 also include images that were previously added, with notations that indicates that these are already added.

In some implementations, a limit is imposed on the total number of images that can be added, enhancing performance and manageability. For example, if the limit is set to 35 images and a user has already included two images, these two images will not be reflected on adding page 308, allowing the user the capacity to add up to 33 additional images. If the user reaches this upper limit, a notification can be displayed on adding page 308, as shown in FIG. 3E, alerting the user that no further images can be added, thereby preventing overload and maintaining system stability.

To exit from adding page 308, users have options such as tapping an exit icon (e.g., ‘x’ icon) or swiping down on adding page 308, as depicted in FIG. 3D. This flexibility in navigation can enhance user control and ease of use. Following the selection of all desired images, the user can proceed by tapping a confirmation icon such as the ‘Next’ icon 310 on adding page 308, which directs to a view of the last selected image, facilitating a final review or further action, as shown in FIGS. 3D and 3F. This sequence of interactions is designed to streamline the process of image management within the UI, ensuring a smooth and intuitive user experience from start to finish.

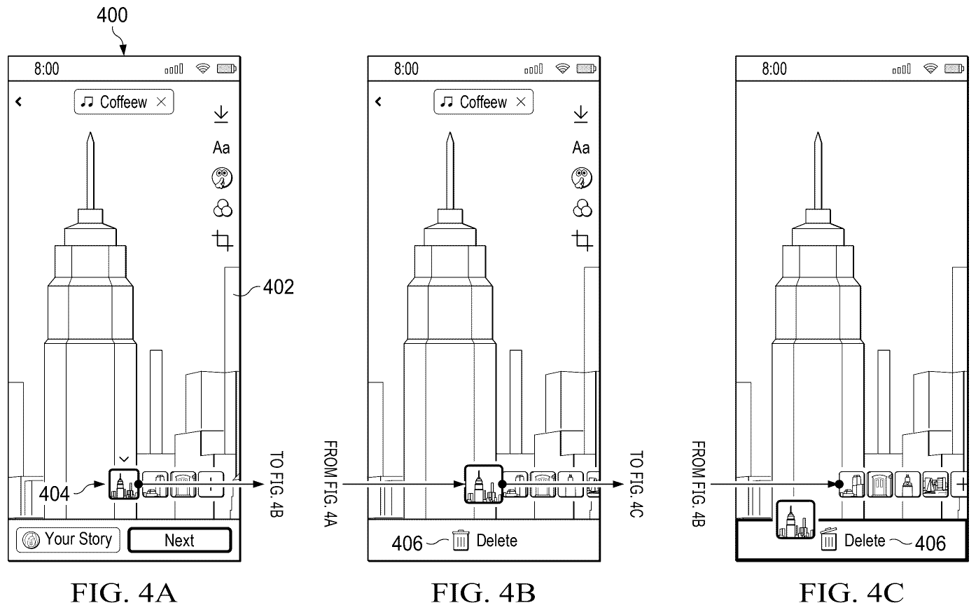

FIGS. 4A-4C illustrate an example UI 400 for media management, according to one or more implementations of the disclosure. In some implementations, UI 400 is integrated with functionalities that enable the removal of one or more images from an image bar, which is designed to facilitate editing processes. This feature can allow users to selectively remove or delete images from the editing queue directly from the image bar on the media editing page, without the need to go to another page for deleting the images. In some implementations, this feature can enhance the usability and customization of the editing workspace. Such a capability can help users efficiently manage their image assets by removing unnecessary or unwanted images, thereby streamlining the editing workflow and maintaining focus on relevant visual content.

As shown in FIG. 4A, a media editing page of UI 400 is composed of image 402 and image bar 404, which includes multiple images. To facilitate image management, a deletion feature is integrated within UI 400, allowing users to remove an image from image bar 404 by executing a long press and dragging the image to a designated area 406, for example, at the bottom of UI 400. Upon detecting a long press, such as a press for a duration exceeding a threshold of time duration, on an image, this designated area 406 is displayed, displaying a trash can icon and a label marked ‘Delete’ to guide the user to the correct location for image deletion, as shown in FIG. 4B. In some implementations, UI 400 includes an upload option area at the bottom of the interface that includes one or more control elements that allows the user to proceed to upload the corresponding images/videos indicated the image bar 404 in different modes, such as, a post mode and a story mode wherein the images/videos would disappear after a certain amount of time. As shown in FIG. 4B, the upload option area includes a control element, labeled as “Your Story,” to allow the user to proceed to upload the corresponding images/videos indicated the image bar in the story mode and another control element, labeled as “Next,” to allow users to proceed to a next step such as a post preparation/editing page in a post creation process. In some implementations, this designated area 406 is displayed by replacing the upload option area that includes the control elements including “Your Story” and “Next”. In some implementations, this designated area 406 is displayed in addition to (e.g., on top of) the upload option area including the control elements including “Your Story” and “Next”. As the user drags the image into this area 406 can become highlighted, for example, by changing a displaying color or effect, signaling that the image is correctly positioned for deletion, as shown in FIG. 4C. Releasing the image within this area 406 finalizes the deletion process, removing the image from image bar 404.

In some implementations, once an image is deleted from image bar 404, it will not reappear on the adding page should the user navigate back to this page. In some implementations, the system enforces a minimum limit on the number of images within image bar 404, requiring that at least two images remain at all times. Attempts to reduce the number of images below this threshold can trigger a notification on UI 400, alerting the user that a minimum of two images must be maintained. This feature can ensure a consistent user experience and prevents the image bar from being left empty, which could disrupt the editing workflow.

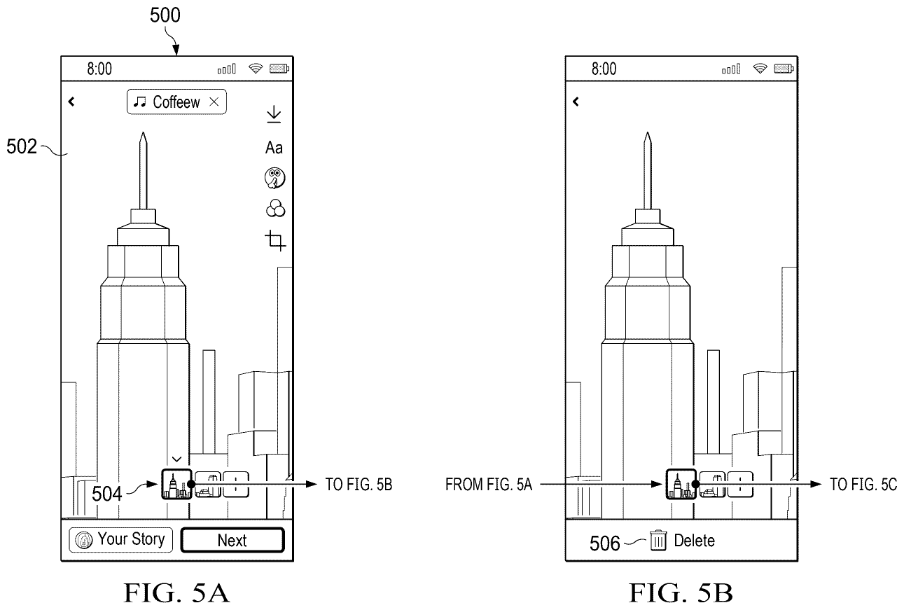

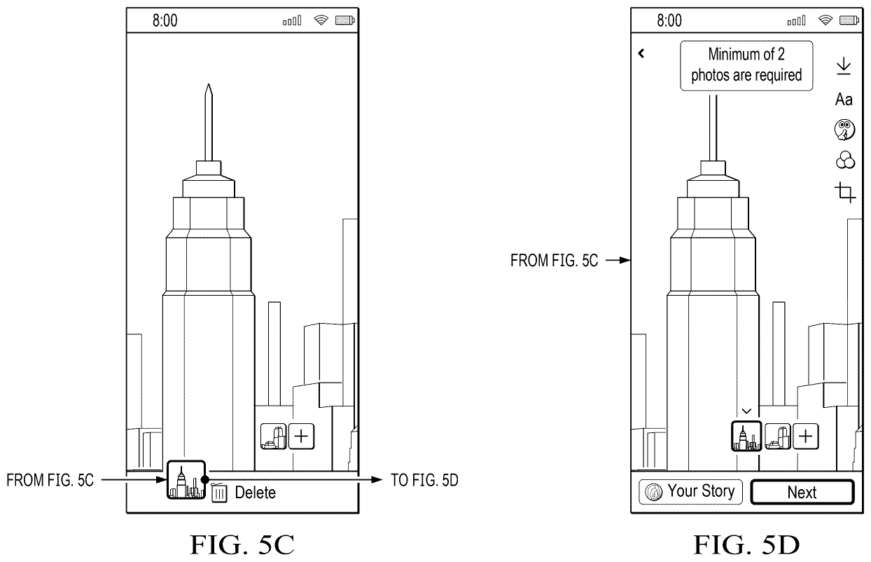

FIGS. 5A-5D illustrate an example UI 500 for media management, according to one or more implementations of the disclosure. In some implementations, UI 500 is integrated with functionalities that not only permit the removal of an image from an image bar for editing purposes but also enable the interruption or cancellation of the removal process. This feature can allow users to initiate the deletion of an image but provides the flexibility to halt or reverse the action if needed. Such capabilities can enhance the user's control over the editing process, ensuring that decisions to remove images can be reconsidered and adjusted dynamically before finalization, thereby accommodating changes in user intent and preventing unintentional deletions. This can add a layer of user-friendly interaction and error mitigation to the photo editing workflow within UI 500.

As shown in FIG. 5A, UI 500 provides a mechanism for users to delete an image from image bar 504 by initiating a long press followed by dragging the image to a designated deletion area such as area 506 at the bottom of the UI, identified as area 506. Upon detecting the long press, the deletion area 506 is displayed, displaying a trash can icon along with a “Delete” label to indicate where users should drag the image to facilitate its removal, as shown in FIGS. 5B and 5C.

The process allows the user to drag the image all the way to the designated deletion area 506 to proceed with the deletion from image bar 504. If the user decides against removing the image during the process, they have the option to cancel this action by dragging the image to a different location outside the designated deletion area 506. Releasing the image outside the highlighted area will cancel the removal process, and the image will remain in image bar 504, as shown in FIG. 5D. This functionality can provide users with greater flexibility and control over image management, allowing for dynamic decision-making and reducing the risk of unintentional deletions by offering an intuitive method to interrupt the deletion process. In shown examples, the upload option area including the control elements “Your Story” and “Next” is replaced by the deletion area including the trash can icon and the “Delete” label when the deletion process is initiated, but reappears after the deletion process is cancelled. After the deletion process is canceled, the deletion area including the trash can icon and the “Delete” label is concealed again.

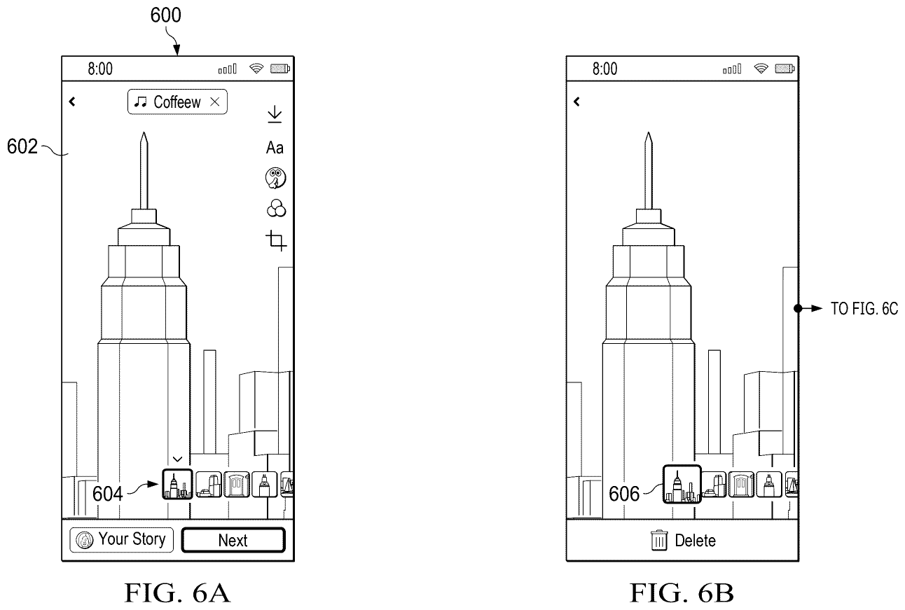

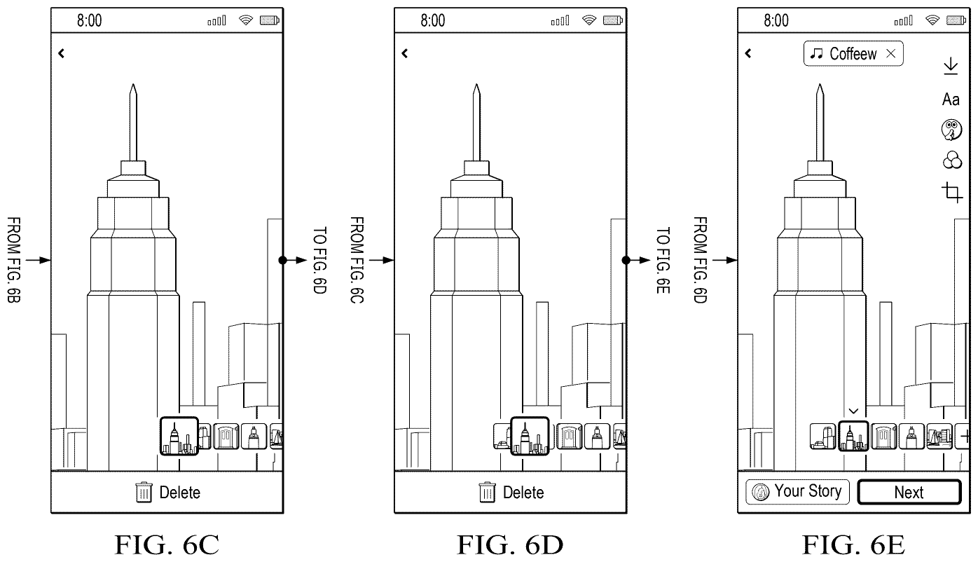

FIGS. 6A-6D illustrate an example UI 600 for media management, according to one or more implementations of the disclosure. In some implementations, UI 600 is integrated with functionalities that enable users to reorder images within an image bar. This feature can allow users to dynamically adjust the order or sequence of images in the image bar, facilitating a customized editing workflow that can be tailored to specific project needs or aesthetic preferences. The ability to reorder images can enhance the flexibility and usability of UI 600, providing users with greater control over the visual layout and progression of their media content within the editing environment.

In some implementations, UI 600 facilitates the reordering or relocation of images within image bar 604. A user can initiate this process by holding and dragging an image to a new position within image bar 604. As shown in FIGS. 6A and 6B, upon long pressing an image in image bar 604 on a media editing page of UI 600, specific UI adjustments can occur to enhance the user interaction. For example, as discussed in connection with FIGS. 5A-5D, in response to detecting a long press of one of the images in the image bar 604, a designated deletion area can be displayed in the media editing page of UI 600. In some implementations, in response to detecting such a user interaction, an adding icon within image bar 604 and other UI elements, such as a media access control element on UI 600, can be temporarily hidden to streamline the view and minimize distractions. In some implementations, the size of the selected image is increased to provide a clear visual cue of the image being manipulated. In some implementations, haptic feedback can be generated and provided to the user to enhance the tactile experience during the drag.

As the user drags the image across the image bar, feedback such as additional haptic feedback or audio feedback can be triggered to provide the user a notification when the image moves past a certain threshold, such as 50%, of the nearest image's position, as shown in FIG. 6C. This feedback is designed to inform the user that they have moved the image a significant distance relative to its starting point or another image. Upon releasing the image at the chosen location within image bar 604, the image is relocated, and its size is restored to its original dimensions, as shown in FIG. 6D. In some implementations, the previously hidden UI elements, including the adding icon and the media access control element, are made visible again on UI 600. This dynamic interplay of visual and tactile feedback with temporary UI adjustments can provide an intuitive and effective way for users to manage and customize the arrangement of images within the editing interface.

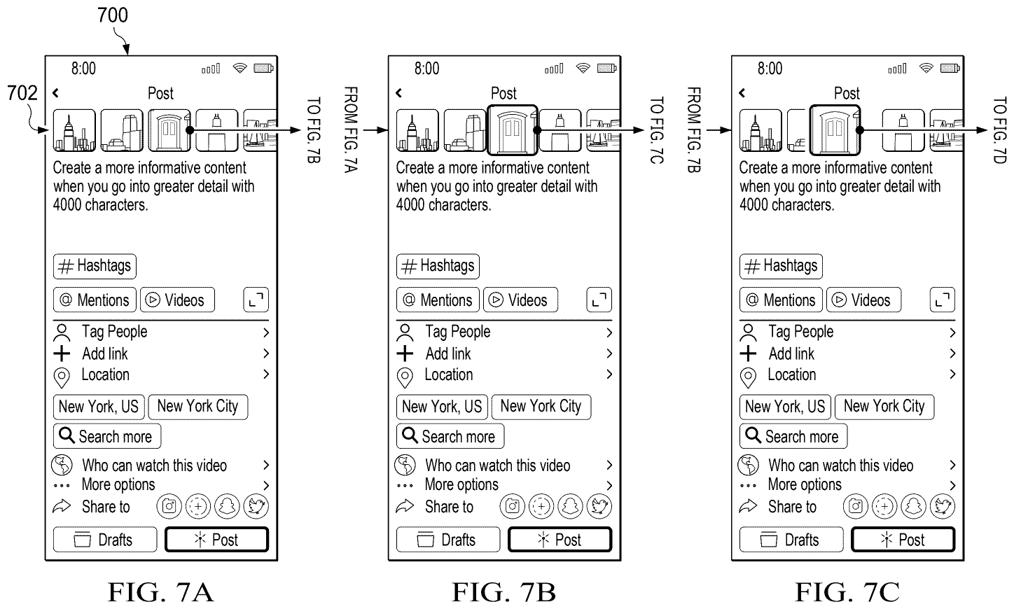

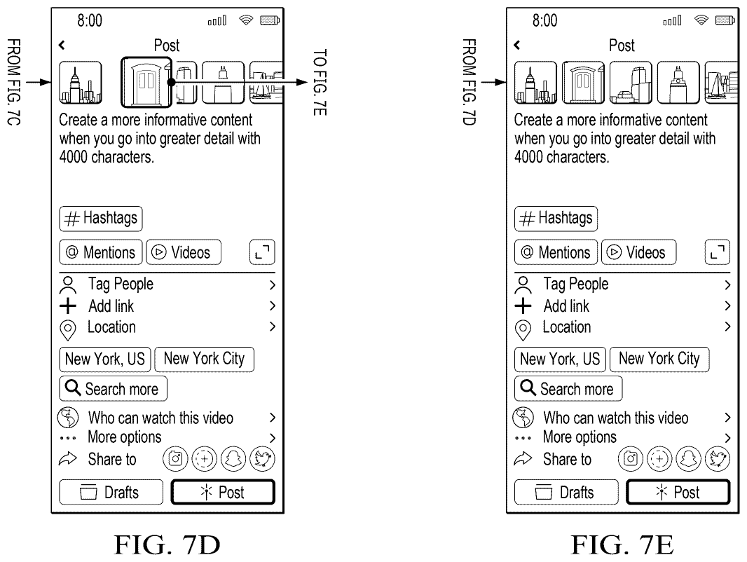

FIGS. 7A-7E illustrate an example UI 700 for media management, according to one or more implementations of the disclosure. In some implementations, UI 700 is integrated with functionalities that enable users to reorder images on a post preparation/editing page of UI 700. This capability can allow users to adjust the sequence of images dynamically, facilitating a tailored visual narrative or presentation directly on the post preparation/editing page. The reordering functionality can further enhance the user's ability to customize the layout of images according to specific preferences or requirements, thereby improving the overall utility and flexibility of UI 700 in managing and displaying media content effectively.

As shown in FIGS. 7A-7E, the post preparation/editing page of UI 700 includes image bar 702 located at the top of the page. In some implementations, users are provided the capability to relocate images within image bar 702 by holding and dragging an image to a new desired position within image bar 702, thereby allowing for the reordering of images. This functionality can enable users to adjust the sequence of images, enhancing the user's control over the visual layout and presentation of content on the post preparation/editing page.

The modifications made to the order of images in image bar 702 on the post preparation/editing page are not isolated to this view alone. If users navigate back to an adding page (e.g., the adding page 308 shown in FIG. 3C), the reordered sequence from the post preparation/editing page can be preserved and reflected on the adding page. Similarly, if users return to a media editing page, the image sequence established on the post preparation/editing page can be consistently maintained and displayed on the media editing page. This synchronization across different pages of UI 700 can ensure that any changes in image ordering are universally applied, maintaining continuity and coherence of the visual content across the user interface. This integration can further enhance the application's usability by providing a consistent and predictable user experience, regardless of the page being accessed.

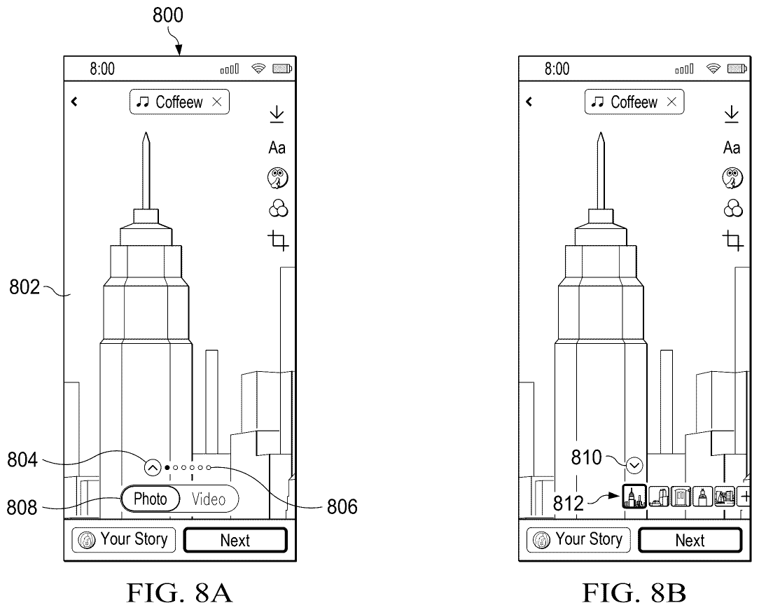

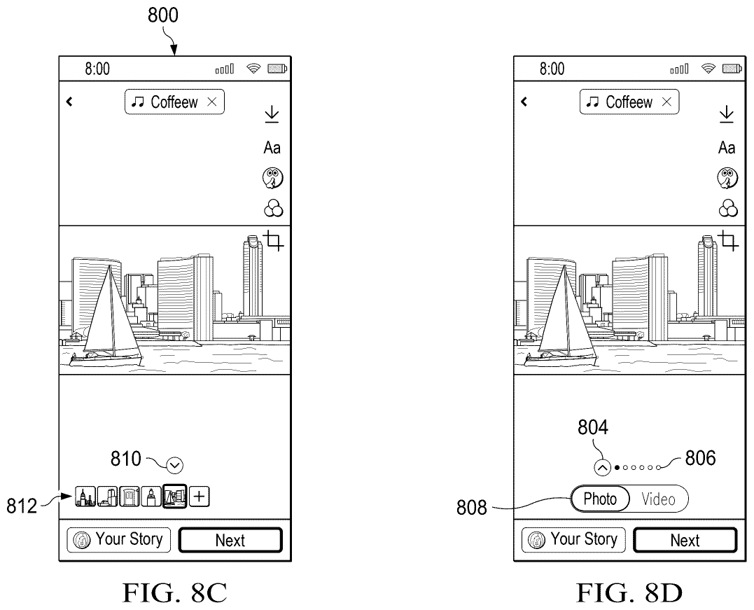

FIGS. 8A-8D illustrate an example UI 800 for media management, according to one or more implementations of the disclosure. In some implementations, UI 800 is designed to include a specific arrangement of control elements that can enhance user interaction and functionality. The relative positioning of these elements within UI 800 can be designed to improve ease of access and efficiency of use.

For example, as shown in FIGS. 8A and 8D, icon 804 of an interactive element for unhiding image bar 812 can be placed next to carousel indicator 806 and above media access control element 808 to facilitate smooth transitions between viewing and editing modes. This configuration can allow users to manage visibility settings and navigate through images with minimal effort, thereby improving the overall user experience and interaction with the interface.

In some examples, as shown in FIGS. 8A and 8B, UI 800 can be configured such that when a user interacts with icon 804 via tapping or swiping up on the display, specific interface elements are dynamically altered. In the shown example, upon these interactions, image bar 812 and icon 810 which serves to hide image bar 812 are made visible on UI 800. Concurrently, the indicator 806 and media access control element 808 is concealed to streamline the interface for the user's editing tasks. This feature can enhance the usability by providing quick access to image bar 812 and simplifying the UI to focus on image selection and manipulation.

Furthermore, as shown in FIGS. 8B and 8C, users can have the additional functionality of scrolling through image bar 812 to select a different image for editing. This capability can allow users to navigate among various images directly from the image bar, thereby facilitating a seamless editing process. The scrolling feature can enable rapid access to a broader range of images without the need to exit the current editing session, improving the workflow and efficiency within UI 800.

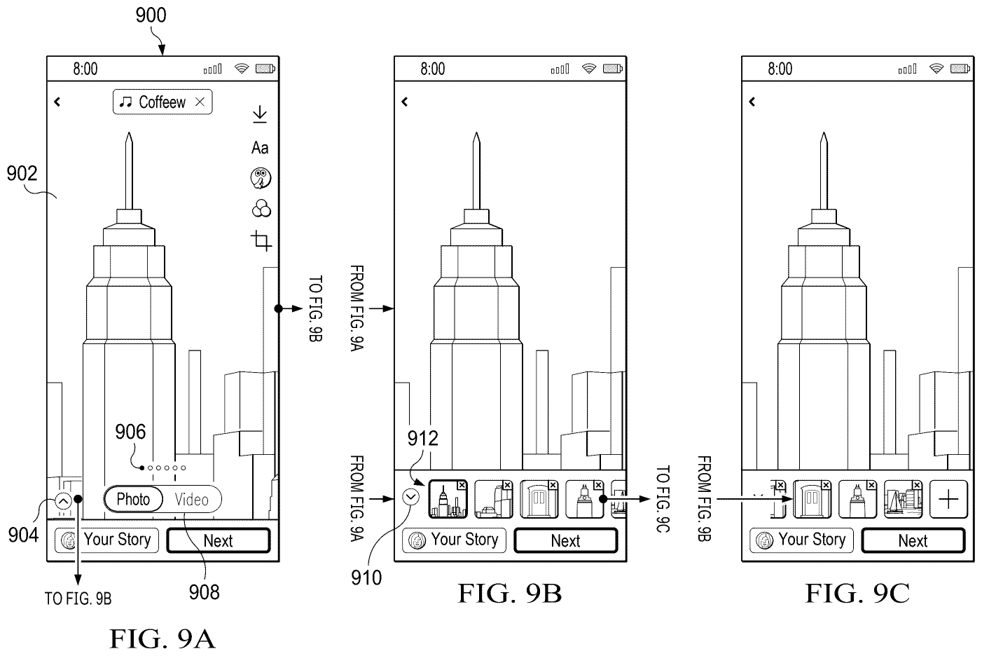

FIGS. 9A-9C illustrate an example UI 900 for media management, according to one or more implementations of the disclosure. In some implementations, UI 900 is designed to include a specific arrangement of control elements that can enhance user interaction and functionality.

As shown in FIG. 9A, within UI 900, icon 904 is positioned at the corner of UI 900, to the left of indicator 906 and media access control element 908. Icon 904 serves as an interactive element for unhiding image bar 912, ensuring placement of UI element for ease of access and intuitive user engagement. Upon user interaction, either through a press on icon 904 or a swipe up on the display of UI 900, a transition occurs whereby icon 904 converts into icon 910, designated for hiding image bar 912. In some implementations, indicator 906 and media access control element 908 become concealed, and image bar 912 becomes visible in an image select panel, which is a dedicated area at the bottom of UI 900.

This configuration can allow users to scroll through image bar 912 within the image select panel to browse and select images. The placement and functionality of the image select panel can leverage existing panel design and interaction patterns, promoting familiarity and consistency in user experience.

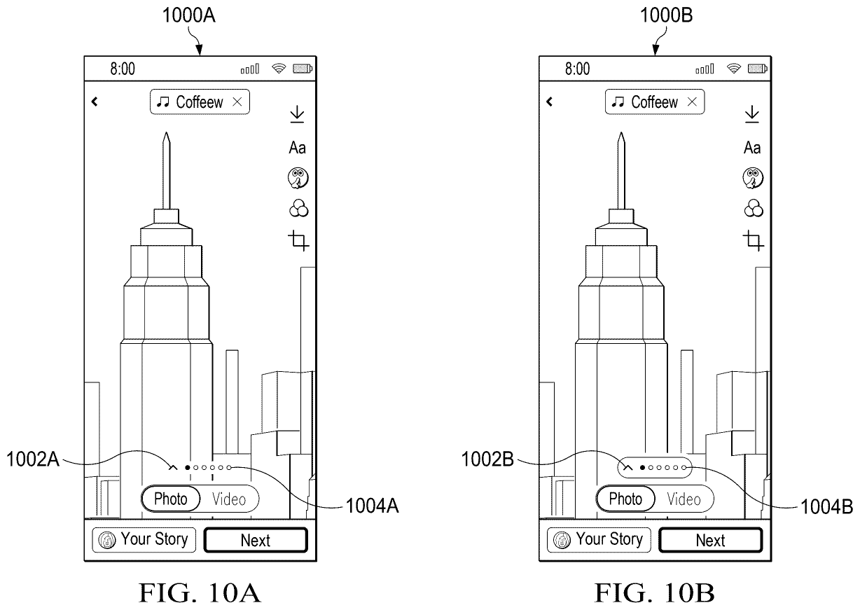

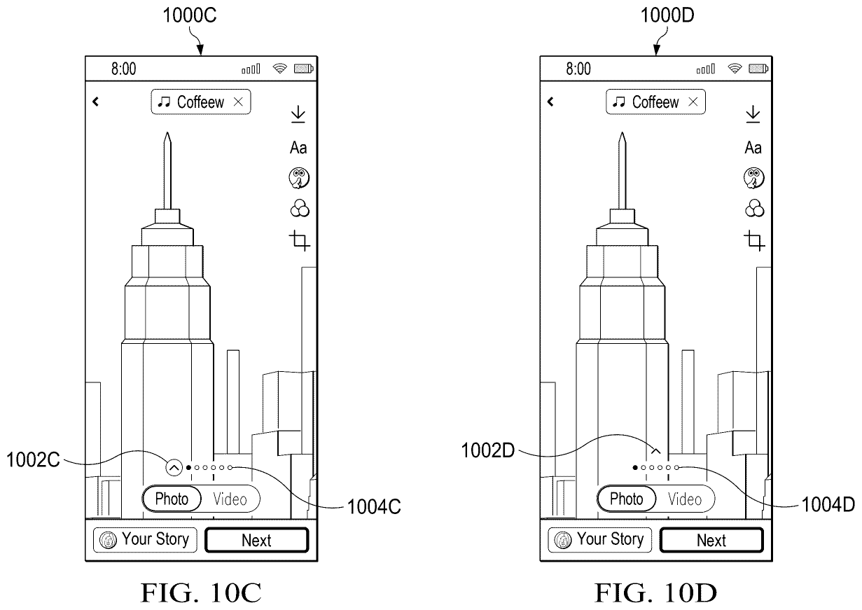

FIGS. 10A-10D illustrate example UIs 1000A-1000D for media management, according to one or more implementations of the disclosure. FIG. 10A illustrates UI 1000A where icon 1002A, utilized for unhiding an image bar, is positioned adjacent to carousel indicator 1004A, aligned side by side to facilitate intuitive user interaction. Similarly, FIG. 10B presents UI 1000B, in which icon 1002B is placed alongside carousel indicator 1004B. In this arrangement, a visual emphasis effect, such as a shadow, is applied to both icon 1002B and indicator 1004B to enhance visibility and aesthetic appeal, thereby improving user engagement. FIG. 10C continues this theme in UI 1000C, showing icon 1002C next to carousel indicator 1004C, also side by side, with a shadow effect applied to icon 1002C to distinguish it visually from other UI elements. FIG. 10D demonstrates a variation in UI 1000D, where icon 1002D is positioned above carousel indicator 1004D, rather than side by side. A similar shadow effect is applied to icon 1002D, maintaining the consistency of visual cues across different UI configurations.

These examples highlight the application of consistent design elements and visual effects across various UI layouts to enhance user navigation and interface usability in media management applications. The placement and distinctive visual treatments can help users locate and utilize these controls within the UI, promoting an efficient and engaging interaction experience. The UI examples, including but not limited to, UI layouts, icons, control elements, styles, and text, depicted herein are provided solely for the purpose of illustration. These elements are exemplary and non-limiting. It should be understood that these elements can be replaced, altered, or modified, for example, in color, size, shape, or another manner departing from the scope of this disclosure.

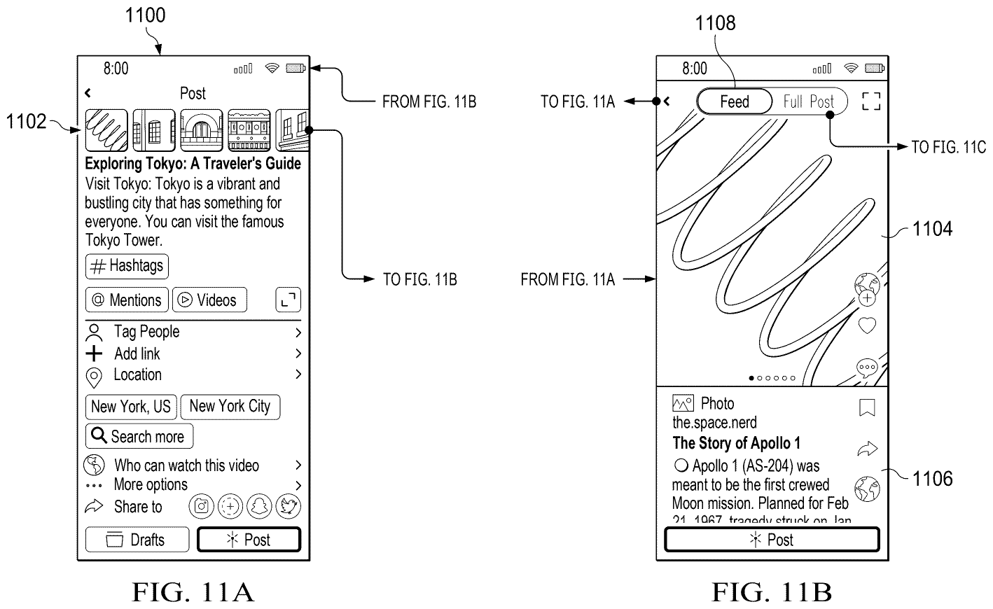

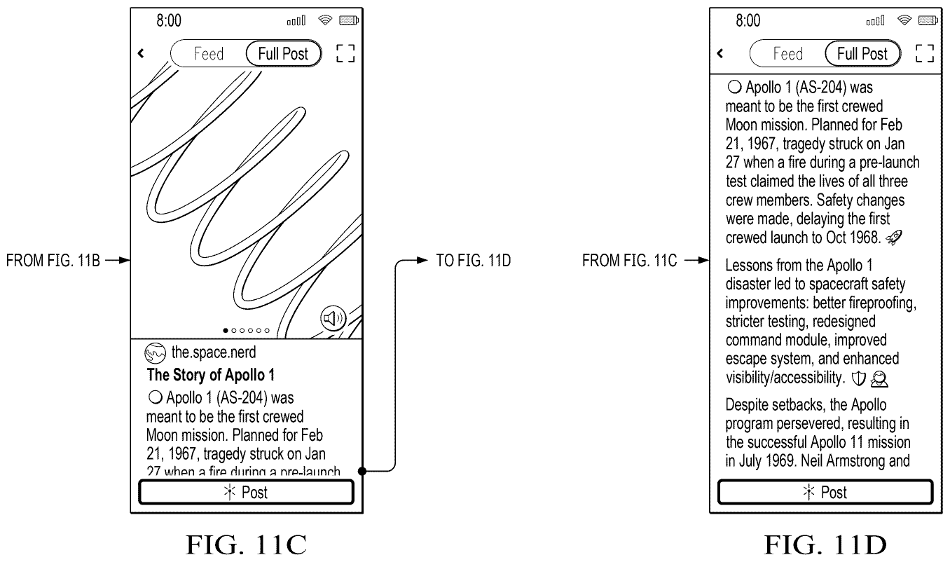

FIGS. 11A-11D illustrate an example UI 1100 for media management, according to one or more implementations of the disclosure. In some implementations, UI 1100 incorporates segmented control functionality, enhancing its capability to switch between multiple post preview modes within a media management application installed on an electronic device.

In some examples, upon activating the post publishing functionality, such as click on an element “Next” on a media editing page, a post preparation/editing page of UI 1100 is displayed, featuring an image bar 1102 that houses multiple images, as shown in FIG. 11A. In some examples, tapping on content, such as selected images or text content, of a post can prompt UI 1100 to transition to a post preview page which displays image 1104 corresponding to the selected image, accompanied by window 1106 containing text content, and a segmented control element 1108, as shown in FIG. 11B.

Segmented control element 1108 is designed to facilitate the toggling between two viewing modes: a feed mode and a full post mode. In some examples, the feed mode can present a personalized stream of videos or images curated based on the user's interests, prior interactions, and viewing habits, enhancing content relevancy and engagement. The full post mode is designed to offer a more immersive viewing experience by expanding the selected media to occupy a larger portion of the screen and displaying comprehensive details such as comments, likes, and shares associated with the media, as shown in FIG. 11C. The full post mode can also support enhanced user interaction with the content, allowing for actions like liking, commenting, sharing, and exploring the content creator's profile. Additional interactive features in the full post mode may include the ability to create duets or stitches with the media, provided these functionalities are enabled by the content creator.

In the full post mode, users can have the option to tap or scroll within window 1106 to access an expanded view of the text content, thus enabling full engagement with the textual elements of the post, as shown in FIG. 11D. This segmented control mechanism can enrich user interaction by offering flexible viewing options that adapt to varying user preferences and engagement levels, facilitating a tailored content consumption experience within UI 1100.

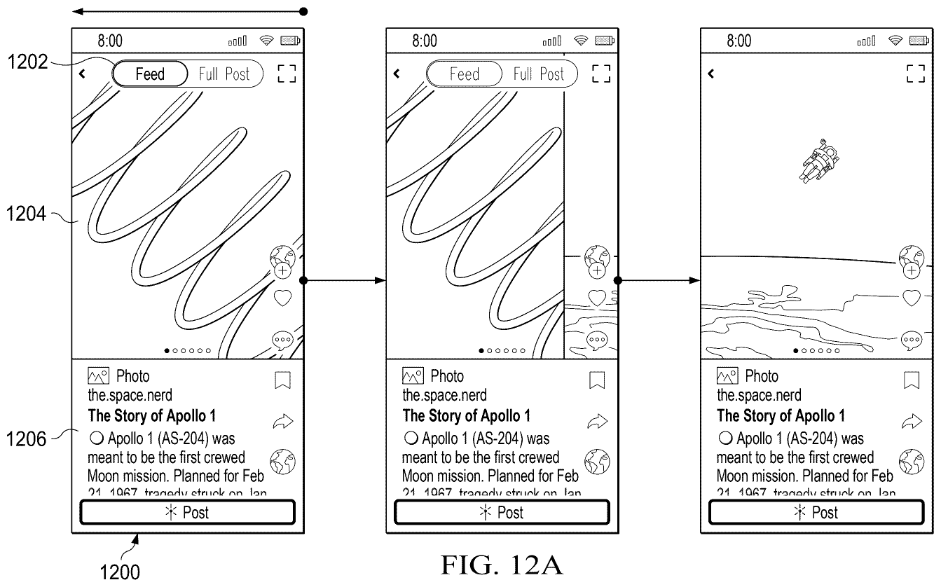

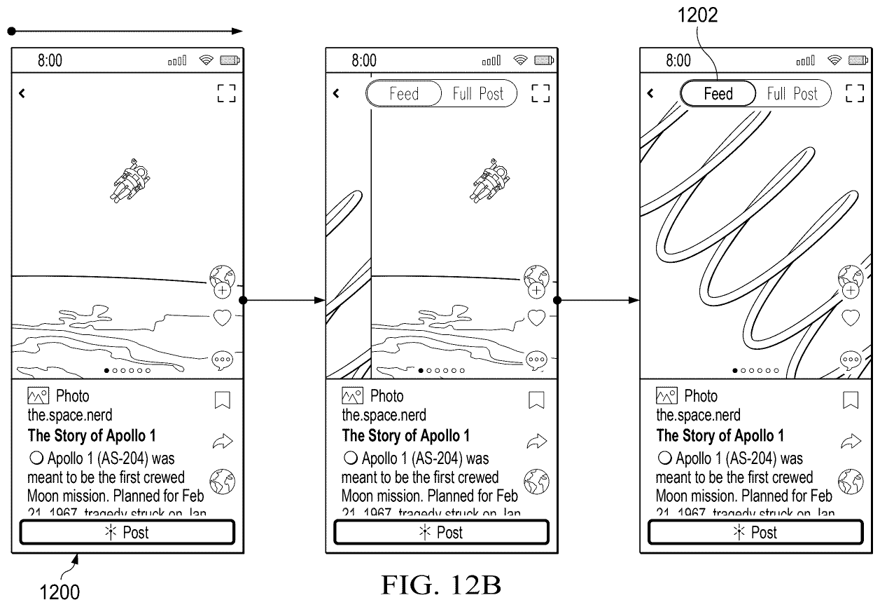

FIGS. 12A and 12B illustrate an example UI 1200 for media management, according to one or more implementations of the disclosure. In some implementations, UI 1200 is integrated with a functionality that enables the hiding and revealing of segment control element 1202, enhancing the aesthetic and operational efficiency of the interface. This functionality is demonstrated on a post preview page of UI 1200 in a feed mode, which displays segment control element 1202 alongside image 1204 and window 1206 containing text content.

In some examples, when a user executes a gesture such as swiping left on the display of UI 1200, segment control element 1202 is designed to disappear, such as by gradually fading out, providing a cleaner and more focused user interface, as shown in FIG. 12A. In some examples, executing a swipe-right gesture on the display will trigger segment control element 1202 to come back into view, as shown in FIG. 12B. In some examples, when the first image of the post is displayed in the UI, segmented control element 1202 is always visible, and performing a swipe-right gesture on the display will not change the visibility of segment control element 1202. In some examples, when a carousel indicator is provided in UI 1200, swipe-left gestures or swipe-right gestures can allow the users to navigate through different images of the post.

This dynamic visibility of segment control element 1202 can allow users to customize their viewing experience on the UI by controlling the display of navigational controls based on their immediate needs, thus improving the usage of screen space and focusing attention on content like images and text. The introduction of intuitive gesture-based commands for controlling element visibility can not only enhance user interaction but also contribute to a more adaptable and user-friendly interface.

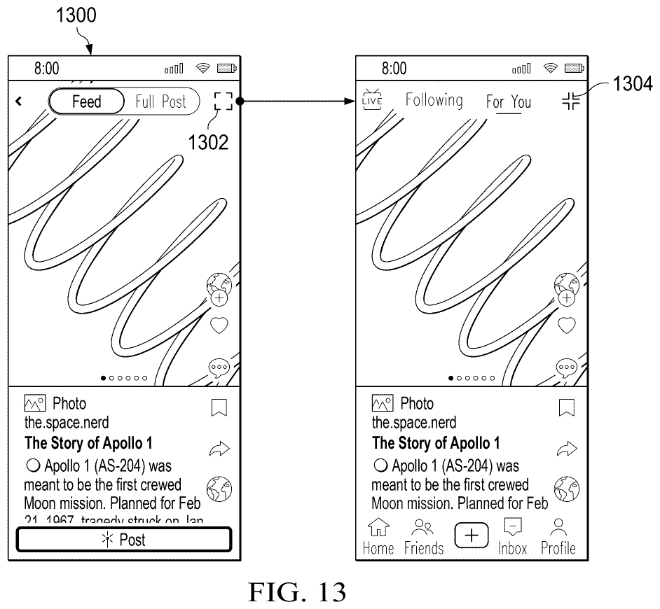

FIG. 13 illustrates an example UI 1300 for media management, according to one or more implementations of the disclosure. In some implementations, UI 1300 includes integrated functionality that facilitates toggling between a full screen view and a collapsed view of a post preview page in a feed mode. This feature can enhance the adaptability of the interface to suit different user preferences for content viewing. As shown, the post preview page in the feed mode includes icon 1302 as a control for expanding the post preview page to a full screen view. When the post preview page is in collapsed view, interaction with icon 1302 enables the user to switch the post preview page to the full screen view. In some implementations, when the post preview page is rendered in a full screen view, some UI elements are selectively hidden or displayed to enhance viewer engagement and screen utilization. In the shown examples of FIG. 13, after switching the post preview page from the collapsed view on the left side to the full screen view on the right side, the segmented control element is obscured from view to provide an unobstructed viewing experience. Elements such as “Following” and “For You” are displayed at the top of the interface, facilitating content navigation and personalization. Additionally, other navigation elements including “Home”, “Friends”, “Inbox”, “Profile”, and an option to add new content are positioned at the bottom of the screen.

When the post preview page is in full screen view, interaction with another icon, designated as icon 1304, enables the user to revert the post preview page back to its original collapsed view. This capability can allow users to switch between expansive and compact views of content, depending on their current interaction needs or screen space requirements.

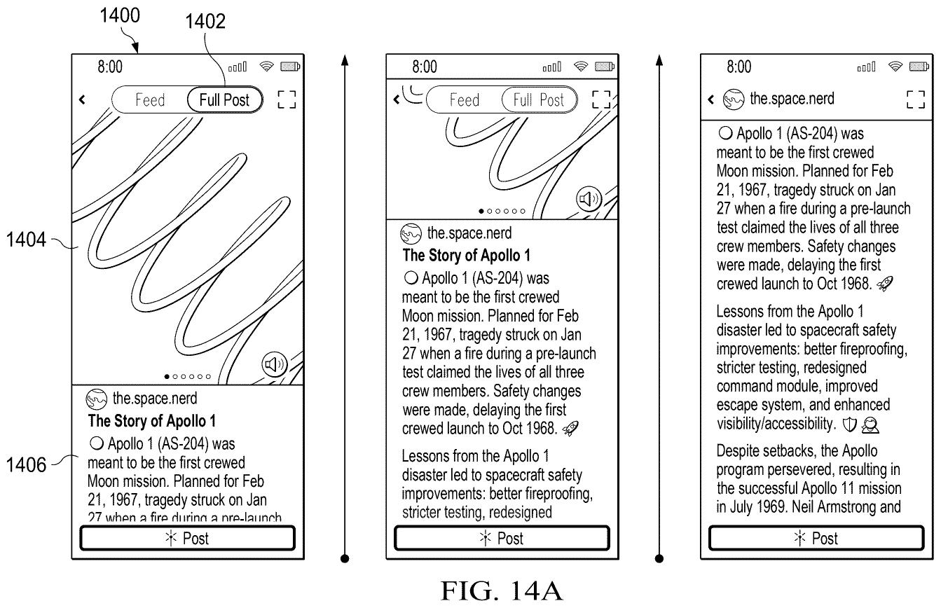

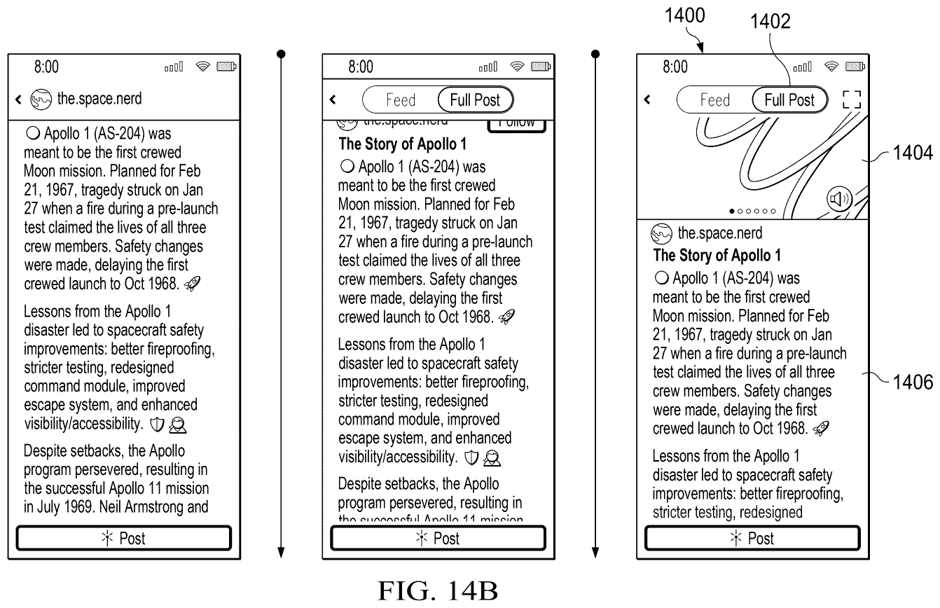

FIGS. 14A and 14B illustrate an example UI 1400 for media management, according to one or more implementations of the disclosure. In some implementations, UI 1400 is integrated with a functionality that enables the hiding and revealing of segment control element 1402, enhancing the aesthetic and operational efficiency of the interface. This functionality is demonstrated on a post preview page of UI 1400 in a full post mode, which displays segment control element 1402 alongside image 1404 and window 1406 containing text content.

In some implementations, UI 1400 is designed to support dynamic resizing of window 1406 through user-initiated gestures, enhancing the interface's responsiveness and adaptability to user needs. In some examples, when a user performs a scrolling-up gesture on window 1406, window 1406 is configured to expand gradually to its full length, as shown in FIG. 14A. This expansion can allow the user to obtain a full view of the text content contained within window 1406, facilitating improved readability and interaction with the content.

In some examples, when a user executes a scrolling-down gesture on window 1406, window 1406 can retract gradually to a reduced length, as shown in FIG. 14B. This contraction reduced the space occupied by the text content, thereby improving the usability of the screen space for other interface interactions.

These features can enable a fluid and intuitive adjustment of the text viewing area within UI 1400, allowing users to customize their viewing experience based on their current content engagement needs.

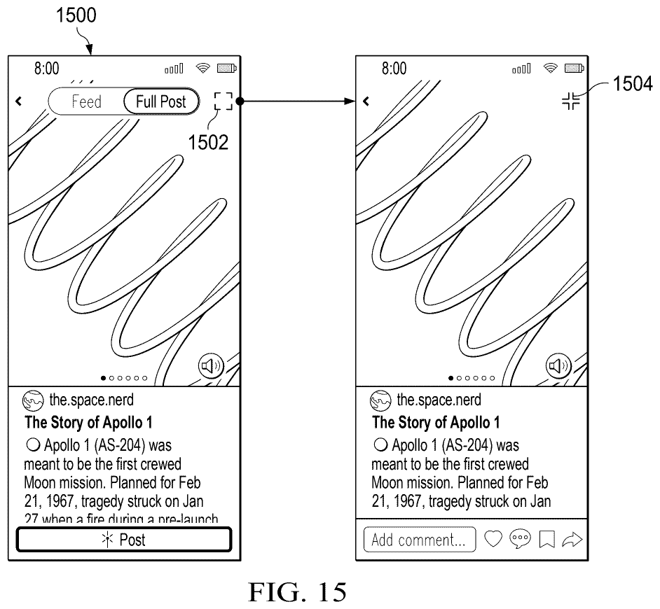

FIG. 15 illustrates an example UI 1500 for media management, according to one or more implementations of the disclosure. In some implementations, UI 1500 includes integrated functionality that facilitates toggling between a full screen view and a collapsed view of a post preview page in a full post mode. This feature can enhance the adaptability of the interface to suit different user preferences for content viewing. As shown, the post preview page in the full post mode includes icon 1502 as a control for expanding the post preview page to a full screen view. When the post preview page is in collapsed view, interaction with icon 1502 enables the user to switch the post preview page to the full screen view.

When the post preview page is in full screen view, interaction with another icon, designated as icon 1504, enables the user to revert the post preview page back to its original collapsed view. This capability can allow users to switch between expansive and compact views of content, depending on their current interaction needs or screen space requirements.

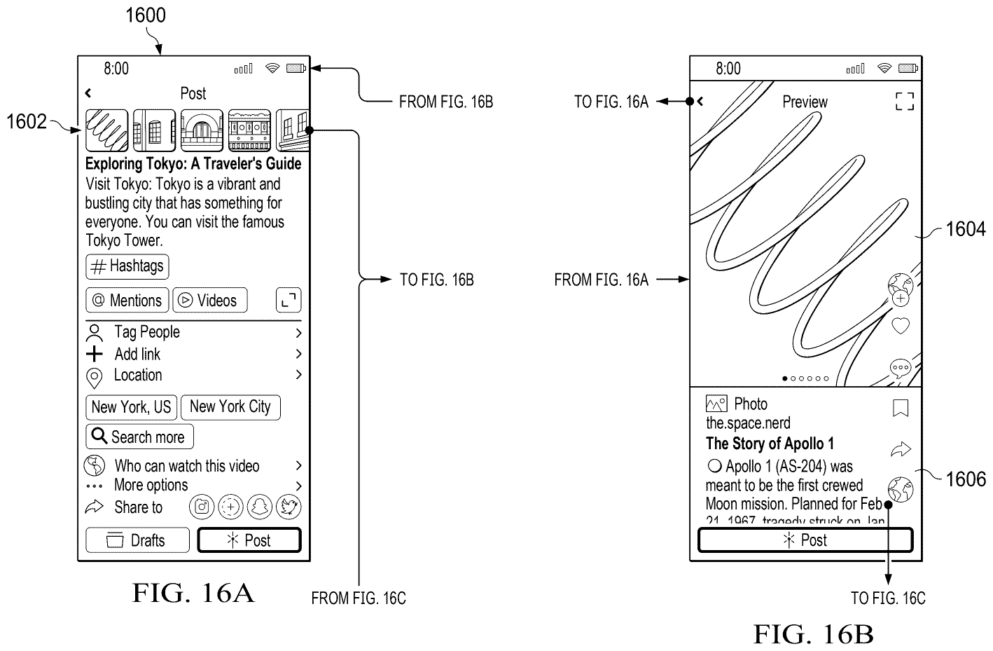

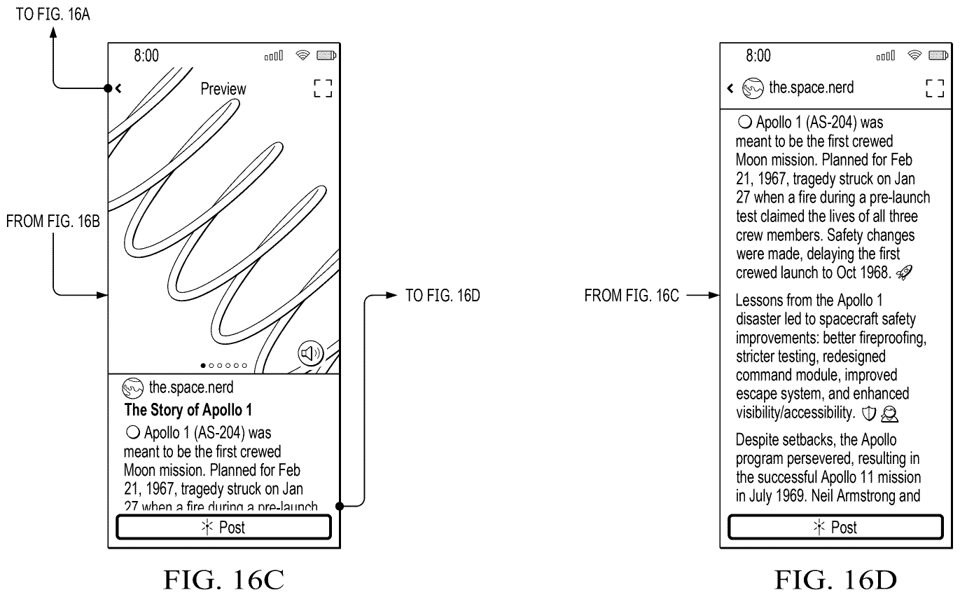

FIGS. 16A-16D illustrates an example UI 1600 for media management, according to one or more implementations of the disclosure. In some implementations, UI 1600 is integrated with functionality that enables switching between multiple preview modes within a media management application installed on an electronic device. In some examples, UI 1600 facilitates transitioning a post preview page between a feed mode and a full post mode without using an explicit segmented control element, as illustrated in FIGS. 16A-16D. This configuration can allow users to engage with content in a manner that best suits their viewing preferences.

For example, when a user selects an image from image bar 1602 on a post preparation/editing page of UI 1600, a post preview page is activated, displaying the selected image 1604 and a text content window 1606, as shown in FIGS. 16A and 16B. Interaction within window 1606, such as tapping the caption of the text content, triggers the post preview page to transition from the feed mode to the full post mode, as shown in FIG. 16C. In the full post mode, as shown in FIG. 16D, users can scroll within window 1606 to access a complete or expanded view of the text content, enhancing the content interaction experience.

In some examples, while in full post mode, users have the option to tap a back button located in the upper left corner of the post preview page to return to the feed mode. This functionality can not only improve navigational efficiency but also enrich user engagement by providing flexible viewing options that adapt to different user interaction needs.

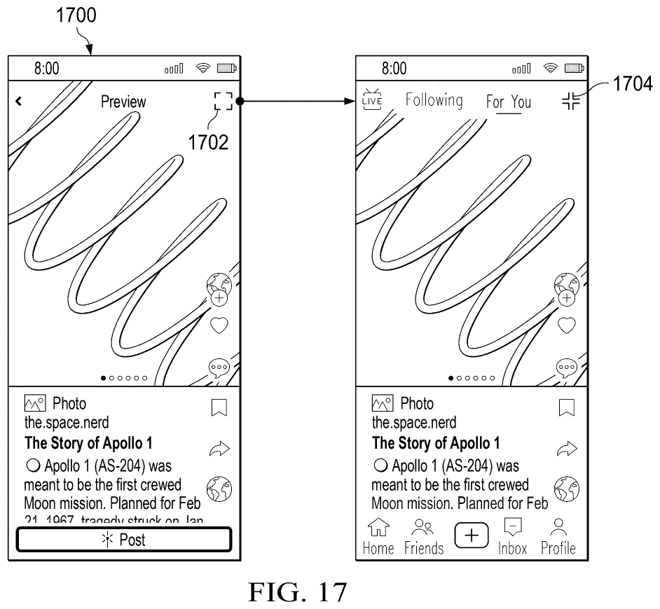

FIG. 17 illustrates an example UI 1700 for media management, according to one or more implementations of the disclosure. In some implementations, UI 1700 includes integrated functionality that facilitates toggling between a full screen view and a collapsed view of a post preview page. In the shown example, this functionality allows for toggling between a full screen view and a collapsed view of a post preview page in a feed mode without a segmented control element.

As shown, the post preview page in the feed mode includes icon 1702 as a control for expanding the post preview page to a full screen view. When the post preview page is in collapsed view, interaction with icon 1702 enables the user to switch the post preview page to the full screen view.

When the post preview page is in full screen view, interaction with another icon, designated as icon 1704, enables the user to revert the post preview page back to its original collapsed view. This capability can allow users to switch between expansive and compact views of content, depending on their current interaction needs or screen space requirements.

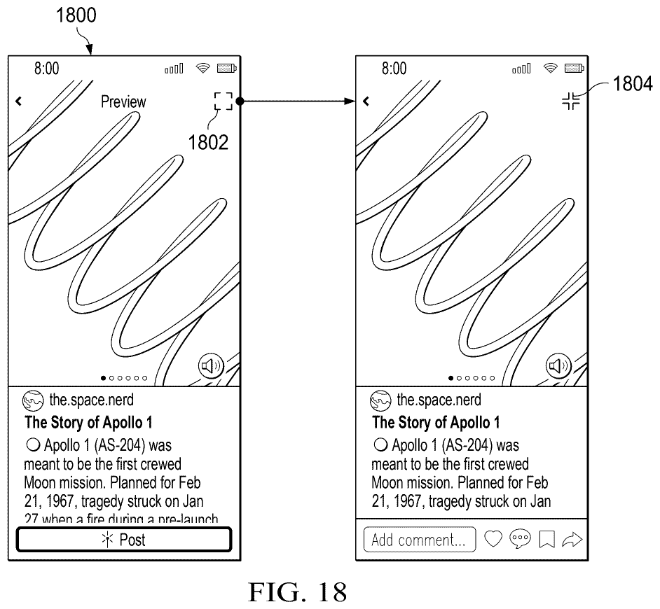

FIG. 18 illustrates an example UI 1800 for media management, according to one or more implementations of the disclosure. In some implementations, UI 1800 includes integrated functionality that facilitates toggling between a full screen view and a collapsed view of a post preview page. In the shown example, this functionality allows for toggling between a full screen view and a collapsed view of a post preview page in a full post mode without a segmented control element.

As shown, the post preview page in the full post mode includes icon 1802 as a control for expanding the post preview page to a full screen view. When the post preview page is in collapsed view, interaction with icon 1802 enables the user to switch the post preview page to the full screen view.

When the post preview page is in full screen view, interaction with another icon, designated as icon 1804, enables the user to revert the post preview page back to its original collapsed view. This capability can allow users to switch between expansive and compact views of content, depending on their current interaction needs or screen space requirements.

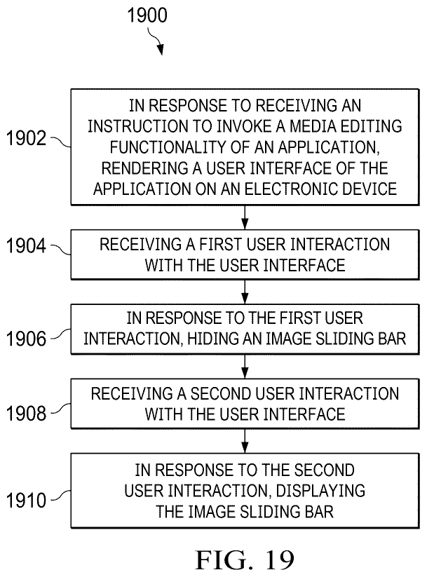

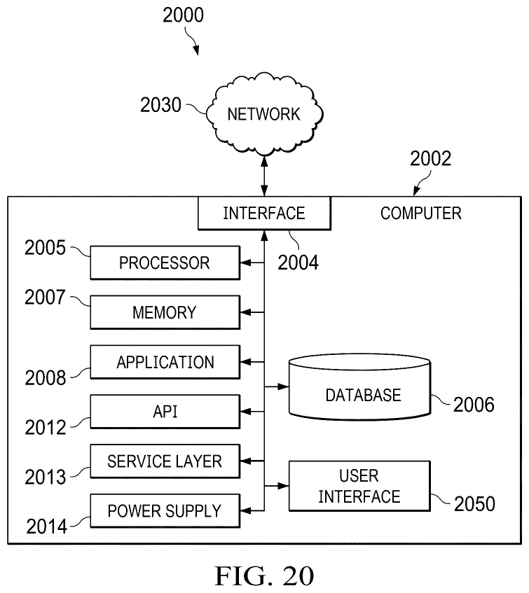

FIG. 19 illustrates a block diagram of an example process 1900 of controlling a UI for media management, according to one or more implementations of the disclosure. The process 1900 can be implemented, for example, by a system executing one or more programs of an application. In some implementations, the system can include an electronic device and one or more servers. The system, the electronic device, and/or the severs each can include one or more processors; and one or more computer-readable memories coupled to the one or more processors and having instructions stored thereon, wherein the instructions are executable by the one or more processors to perform some or all operations of the process 1900, and/or additional or different operations. Process 1900 will be described with reference to elements as illustrated in one or more of FIGS. 1-18. It should be noted that while the elements in one or more of FIGS. 1-18 are described herein as examples, these are not meant to be limiting, process 1900 can be performed with respect to any suitable elements. The operations shown in process 1900 may not be exhaustive and that other operations can be performed as well before, after, or in between any of the illustrated operations. Further, some of the operations may be performed simultaneously, or in a different order than shown in FIG. 19.

An electronic device renders a user interface (UI) (e.g., UI 200) of an application on the electronic, in response to receiving an instruction to invoke a media editing functionality of the application (1902). The application can be, for example, a video sharing application as described above. In some implementations, the instruction to invoke the media editing functionality is received after a user selects or enters one or more media content for creating a post. For example, the instruction to invoke the media editing functionality can be a user interaction with an explicit icon indicating editing functionality (e.g., an icon labeled as “Edit”) shown on a post creating page, or an implicit icon indicating the completion of the selection or entry of the media content for creating a post (e.g., an icon labeled as “Next” or “Confirm” in an image/video selection page).

In some implementations, the UI includes a first image (e.g., image 202) and an image sliding bar (e.g., image bar 206). The image sliding bar includes a plurality of selected images, and the plurality of selected images respectively correspond to a number of images stored in a media library accessible by the application.

In some implementations, the UI further includes an icon of a first interaction elements, and the icon of the first interactive element is switchable between a first icon (e.g., icon 204) and a second icon (e.g., icon 208) based on user interactions with the first interactive element.

A first user interaction with the UI is received (1904). In some examples, the first user interaction comprises a swipe-down gesture on the user interface or a tap on the first icon of the first interactive element.

The image sliding bar is hidden in response to the first user interaction (1906). In some implementations, in response to the first user interaction, the first icon (e.g., icon 204) of the first interactive element is switched to the second icon (e.g., icon 208) of the first interaction element.

A second user interaction with the UI is received (1908). In some examples, the second user interaction can include a swipe-up gesture on the user interface or a tap on the second icon of the first interactive element.

The image sliding bar is displayed in response to the second user interaction (1910). In some implementations, in response to the user interaction, the second icon (e.g., icon 208) of the first interactive element is switched back to the first icon (e.g., icon 204) of the first interaction element.

In some implementations, after hiding the image sliding bar and in response to detecting no user interaction with the UI for a time period, a second user interactive element (e.g., indicator 210) is displayed on the UI. In some examples, the second user interactive element includes a carousel indicator. In such implementations, a third user interaction with the UI is received, and the image sliding bar is displayed in response to the third user interaction. In some examples, the third user interaction can include a swipe-up gesture or a tap on the second user interactive element.

In some implementations, the image sliding bar further includes a third interactive element (e.g., icon 306) for accessing the media library accessible by the application. In such implementations, a fourth user interaction with the UI is received, and the media library (e.g., adding page 308) is displayed in response to the fourth user interaction. In some examples, the fourth user interaction includes a tapping on the third interactive element.

In some implementations, a fifth user interaction with a particular image of the plurality of selected images in the image sliding bar (e.g., image bar 404). In some examples, the fifth user interaction with the particular image includes pressing the particular image for a duration longer than a threshold. In response to the fifth user interaction with the particular image, a deletion icon is displayed in a space of the user interface other than a space occupied by the image sliding bar. The fifth user interaction further includes moving the particular image to a particular location on the user interface within the space of the user interface other than the space occupied by the image sliding var, and releasing the particular image at the particular location. In response to the releasing, the particular image is removed from the image sliding bar. In some implementations, the space of the user interface other than the space occupied by the image sliding bar include an area under the image sliding bar.

In some implementations, a sixth user interaction with a particular image of the plurality of selected images in the image sliding bar (e.g., image bar 604) is received. In some examples, the sixth user interaction includes: moving, while pressing on the particular image, the particular image to another location in the image sliding bar; and releasing the particular image at the another location. In such implementations, in response to the sixth user interaction, a display order of the plurality of selected images is rearranged in the image sliding bar, and the particular image is displayed in a location between two images of the plurality of selected images that are nearest to the another location.

In some implementations, an instruction to invoke a post publishing functionality of the application is received. In such implementations, in response to the instruction, the electronic device renders another UI (e.g., UI 1100) of the application on the electronic device. In some examples, the another UI includes icons (e.g., segmented control element 1108) representing multiple preview modes, and the multiple preview modes comprises a feed mode and a full post mode. In such implementations, a selection of the full post mode is received, and a particular image (e.g., image 1404) and a window (e.g., window 1406) including text context are concurrently displayed in the full post mode.

In some implementations, a seventh user interaction with the window including the text content is received in the full post mode. In such implementations, an expanded window is provided to show an expanded view of the text content in response to the seventh user interaction.

FIG. 20 illustrates a block diagram of an example computer system 2000 used to provide computational functionalities associated with described algorithms, methods, functions, processes, flows, and procedures, as described in the disclosure, according to one or more implementations. The example computer system 2000 can include an electronic device 2002 and a network 2030. The computer system 2000 can include additional or different components, such as, one or more remote servers that are communicatively linked with the electronic device 2002.

The electronic device 2002 can include a digital TV, a desktop computer, a work station, a smart appliance, or another stationary terminal. In some implementations, the electronic device 2002 is a portable device, such as, a notebook computer, a digital broadcast receiver, a handheld device, a portable multimedia player (PMP), an in-vehicle terminal, an Internet of Things (IoT) device. For example, the electronic device 2002 can be a phone, a smartphone, a pad (tablet computer), a digital assistant device (e.g., a PDA (personal digital assistant)), or another handheld device.

In some aspects, the electronic device 2002 may include a computer that includes a user interface 2050. The user interface 2050 can include an input device, such as a keypad, keyboard, touch screen/touch display, camera, microphone, accelerometer, gyroscope, AR/VR sensors, or other device that can accept user information, and an output device that conveys information associated with the operation of the electronic device 2002, including digital data, visual, or audio information (or a combination of information), or a graphical user interface (GUI). In some implementations, the user interacts with the GUI, for example, through contacts and/or gestures on or in front of the touch screen, for example, to implement the functions such as digital photographing/videoing, instant messaging, social network interacting, image/video editing, drawing, presenting, word/text processing, website creating, game playing, telephoning, video conferencing, e-mailing, web browsing, digital music/digital video playing, etc.

The electronic device 2002 can serve in a role as a client, network component, a server, a database or other persistency, or any other component (or a combination of roles) of a computer system for performing the subject matter described in the instant disclosure. The illustrated electronic device 2002 is communicably coupled with a network 2030. In some implementations, one or more components of the electronic device 2002 may be configured to operate within environments, including cloud-computing-based, local, global, or other environment (or a combination of environments).

At a high level, the electronic device 2002 is an electronic computing device operable to receive, transmit, process, store, or manage data and information associated with the described subject matter. According to some implementations, the electronic device 2002 may also include, or be communicably coupled with, an application server, e-mail server, web server, caching server, streaming data server, or other server (or a combination of servers).

The electronic device 2002 can receive requests over network 2030 from a client application (for example, executing on another electronic device 2002) and respond to the received requests by processing the received requests using an appropriate software application(s). In addition, requests may also be sent to the electronic device 2002 from internal users (for example, from a command console or by other appropriate access methods), external or third-parties, other automated applications, as well as any other appropriate entities, individuals, systems, or computers.

Each of the components of the electronic device 2002 can communicate using a system bus. In some implementations, any or all of the components of the electronic device 2002, hardware or software (or a combination of both hardware and software), may interface with each other or the interface 2004 (or a combination of both), over the system bus using an application programming interface (API) 2012 or a service layer 2013 (or a combination of the API 2012 and service layer 2013). The API 2012 may include specifications for routines, data structures, and object classes. The API 2012 may be either computer-language independent or dependent and refer to a complete interface, a single function, or even a set of APIs. The service layer 2013 provides software services to the electronic device 2002 or other components (whether or not illustrated) that are communicably coupled to the electronic device 2002. The functionality of the electronic device 2002 may be accessible for all service consumers using this service layer. Software services, such as those provided by the service layer 2013, provide reusable, defined functionalities through a defined interface. For example, the interface may be software written in JAVA, C++, or other suitable language providing data in extensible markup language (XML) format or other suitable formats. While illustrated as an integrated component of the electronic device 2002, alternative implementations may illustrate the API 2012 or the service layer 2013 as stand-alone components in relation to other components of the electronic device 2002 or other components (whether or not illustrated) that are communicably coupled to the electronic device 2002. Moreover, any or all parts of the API 2012 or the service layer 2013 may be implemented as child or sub-modules of another software module, enterprise application, or hardware module without departing from the scope of this disclosure.

The electronic device 2002 includes an interface 2004. Although illustrated as a single interface 2004 in FIG. 20, two or more interfaces 2004 may be used according to particular needs, desires, or particular implementations of the electronic device 2002. The interface 2004 is used by the electronic device 2002 for communicating with other systems that are connected to the network 2030 (whether illustrated or not) in a distributed environment. Generally, the interface 2004 includes logic encoded in software or hardware (or a combination of software and hardware) and is operable to communicate with the network 2030. More specifically, the interface 2004 may include software supporting one or more communication protocols associated with communications such that the network 2030 or interface's hardware is operable to communicate physical signals within and outside of the illustrated electronic device 2002.

The electronic device 2002 includes a processor 2005. Although illustrated as a single processor 2005 in FIG. 20, two or more processors may be used according to particular needs, desires, or particular implementations of the electronic device 2002. Generally, the processor 2005 executes instructions and manipulates data to perform the operations of the electronic device 2002 and any algorithms, methods, functions, processes, flows, and procedures as described in the instant disclosure.

The electronic device 2002 also includes a database 2006 that can hold data for the electronic device 2002 or other components (or a combination of both) that can be connected to the network 2030 (whether illustrated or not). For example, database 2006 can be an in-memory, conventional, or other type of database storing data consistent with this disclosure. In some implementations, database 2006 can be a combination of two or more different database types (for example, a hybrid in-memory and conventional database) according to particular needs, desires, or particular implementations of the electronic device 2002 and the described functionality. Although illustrated as a single database 2006 in FIG. 20, two or more databases (of the same or combination of types) can be used according to particular needs, desires, or particular implementations of the electronic device 2002 and the described functionality. While database 2006 is illustrated as an integral component of the electronic device 2002, in alternative implementations, database 2006 can be external to the electronic device 2002.

The electronic device 2002 also includes a memory 2007 that can hold data for the electronic device 2002 or other components (or a combination of both) that can be connected to the network 2030 (whether illustrated or not). For example, memory 2007 can include a non-transitory computer readable storage medium or other computer program product that store executable instructions configured for execution by one or more processors 2005 for performing the functionality described in this disclosure. Memory 2007 can be Random Access Memory (RAM), Read Only Memory (ROM), optical, magnetic, and the like, storing data consistent with this disclosure. In some implementations, memory 2007 can be a combination of two or more different types of memory (for example, a combination of RAM and magnetic storage) according to particular needs, desires, or particular implementations of the electronic device 2002 and the described functionality. Although illustrated as a single memory 2007 in FIG. 20, two or more memories 2007 (of the same or a combination of types) can be used according to particular needs, desires, or particular implementations of the electronic device 2002 and the described functionality. While memory 2007 is illustrated as an integral component of the electronic device 2002, in alternative implementations, memory 2007 can be external to the electronic device 2002.

The application 2008 is an algorithmic software engine providing functionality according to particular needs, desires, or particular implementations of the electronic device 2002, particularly with respect to functionality described in this disclosure. The application 808 can be associated with a platform that includes one or more application servers. For example, application 2008 can include one or more of a social network application, video sharing application, text/image/video/audio editing/presentation application, etc. Application 2008 can serve as one or more components, modules, or applications. Further, although illustrated as a single application 2008, the application 2008 may be implemented as multiple applications 2008 on the electronic device 2002. In addition, although illustrated as integral to the electronic device 2002, in alternative implementations, at least part of the application 2008 can be external to the electronic device 2002. For example, one or more programs of the application 2008 can execute on an application server remote to the electronic device 2002.

The electronic device 2002 can also include a power supply 2014. The power supply 2014 can include a rechargeable or non-rechargeable battery that can be configured to be either user- or non-user-replaceable. In some implementations, the power supply 2014 can include power-conversion or management circuits (including recharging, standby, or other power management functionality). In some implementations, the power supply 2014 can include a power plug to allow the electronic device 2002 to be plugged into a wall socket or other power source to, for example, power the electronic device 2002 or recharge a rechargeable battery.

There may be any number of computers 2002 associated with, or external to, a computer system containing electronic device 2002, each electronic device 2002 communicating over network 2030. Further, the term “client,” “user,” and other appropriate terminology may be used interchangeably, as appropriate, without departing from the scope of this disclosure. Moreover, this disclosure contemplates that many users may use one electronic device 2002, or that one user may use multiple computers 2002.

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations, but should be defined only in accordance with the following claims and their equivalents. Accordingly, other implementations also are within the scope of the claims.

What is claimed is:

1. A method, comprising:
in response to receiving an instruction to invoke a media editing functionality of an application, rendering, by an electronic device, a user interface of the application on the electronic device, wherein the user interface comprises a first image and an image sliding bar, wherein the image sliding bar comprises a plurality of selected images, and wherein the plurality of selected images respectively correspond to a plurality of images stored in a media library accessible by the application;
receiving a first user interaction with the user interface;
in response to the first user interaction, hiding the image sliding bar;
receiving a second user interaction with the user interface; and
in response to the second user interaction, displaying the image sliding bar.

2. The method of claim 1, wherein the user interface further comprises an icon of a first interactive element, and the icon of the first interactive element is switchable between a first icon and a second icon based on user interactions with the first interactive element.

3. The method of claim 2, wherein the first user interaction comprises a swipe-down gesture on the user interface or a tap on the first icon of the first interactive element.

4. The method of claim 2, wherein in response to the first user interaction, the method further comprises:
switching the first icon of the first interactive element to the second icon of the first interactive element.

5. The method of claim 2, wherein the second user interaction comprises a swipe-up gesture on the user interface or a tap on the second icon of the first interactive element.

6. The method of claim 2, wherein in response to the second user interaction, the method further comprises:
switching the second icon of the first interactive element to the first icon of the first interactive element.

7. The method of claim 1, further comprising:
after hiding the image sliding bar and in response to detecting no user interaction with the user interface for a time period, displaying a second user interactive element on the user interface, wherein the second user interactive element comprise a carousel indicator.

8. The method of claim 7, further comprising:
receiving a third user interaction with the user interface, wherein the third user interaction comprises a swipe-up gesture or a tap on the second user interactive element; and
in response to the third user interaction, displaying the image sliding bar.

9. The method of claim 1, wherein the image sliding bar further comprises a third interactive element for accessing the media library accessible by the application, and the method comprises:
receiving a fourth user interaction with the third interactive element; and
in response to receiving the fourth user interaction with the third interactive element, displaying the media library.

10. The method of claim 1, further comprising:
receiving a fifth user interaction with a particular image of the plurality of selected images in the image sliding bar, wherein the fifth user interaction with the particular image comprises pressing the particular image for a duration longer than a threshold;
in response to the fifth user interaction with the particular image, displaying a deletion icon in a space of the user interface other than a space occupied by the image sliding bar;
determining that the fifth user interaction further comprises:
moving the particular image to a particular location on the user interface within the space of the user interface other than the space occupied by the image sliding bar; and
releasing the particular image at the particular location; and
in response to the releasing, removing the particular image from the image sliding bar.

11. The method of claim 10, wherein the space of the user interface other than the space occupied by the image sliding bar comprises an area under the image sliding bar.

12. The method of claim 1, further comprising:
receiving a sixth user interaction with a particular image of the plurality of selected images in the image sliding bar, wherein the sixth user interaction with the particular image comprises:
moving, while pressing on the particular image, the particular image to another location in the image sliding bar; and
releasing the particular image at the another location; and
in response to the sixth user interaction with the particular image, rearranging a display order of the plurality of selected images in the image sliding bar and displaying the particular image in a location between two images of the plurality of selected images that are nearest to the another location.

13. The method of claim 1, further comprising:
in response to receiving an instruction to invoke a post publishing functionality of the application, rendering, by the electronic device, another user interface of the application on the electronic device, wherein the another user interface comprises icons representing multiple preview modes, and the multiple preview modes comprises a feed mode and a full post mode;
receiving a selection of the full post mode;
in response to the selection of the full post mode, concurrently displaying a particular image and a window comprising text content in the full post mode;
receiving a seventh user interaction with the window comprising the text content in the full post mode; and
in response to the seventh user interaction with the window comprising the text content in the full post mode, providing an expanded window to show an expanded view of the text content.

14. An apparatus, comprising:
one or more processors; and
one or more computer-readable memories coupled to the one or more processors and having instructions stored thereon, wherein the instructions are executable by the one or more processors to perform operations comprising:
in response to receiving an instruction to invoke a media editing functionality of an application, rendering a user interface of the application on the apparatus, wherein the user interface comprises a first image and an image sliding bar, wherein the image sliding bar comprises a plurality of selected images, and wherein the plurality of selected images respectively correspond to a plurality of images stored in a media library accessible by the application;
receiving a first user interaction with the user interface;
in response to the first user interaction, hiding the image sliding bar;
receiving a second user interaction with the user interface; and
in response to the second user interaction, displaying the image sliding bar.

15. A non-transitory computer readable storage medium, wherein the non-transitory computer readable storage medium stores programing instructions executable by one or more processors to perform operations comprising:
in response to receiving an instruction to invoke a media editing functionality of an application, rendering a user interface of the application on an electronic device, wherein the user interface comprises a first image and an image sliding bar, wherein the image sliding bar comprises a plurality of selected images, and wherein the plurality of selected images respectively correspond to a plurality of images stored in a media library accessible by the application;
receiving a first user interaction with the user interface;
in response to the first user interaction, hiding the image sliding bar;
receiving a second user interaction with the user interface; and
in response to the second user interaction, displaying the image sliding bar.

16. The non-transitory computer readable storage medium according to claim 15, wherein the user interface further comprises an icon of a first interactive element, and the icon of the first interactive element is switchable between a first icon and a second icon based on user interactions with the first interactive element.

17. The non-transitory computer readable storage medium according to claim 16, wherein the first user interaction comprises a swipe-down gesture on the user interface or a tap on the first icon of the first interactive element.

18. The non-transitory computer readable storage medium according to claim 16, wherein the non-transitory computer readable storage medium stores programing instructions executable by the one or more processors to perform operations comprising:
in response to the first user interaction, switching the first icon of the first interactive element to the second icon of the first interactive element.

19. The non-transitory computer readable storage medium according to claim 16, wherein the second user interaction comprises a swipe-up gesture on the user interface or a tap on the second icon of the first interactive element.

20. The non-transitory computer readable storage medium according to claim 16, wherein the non-transitory computer readable storage medium stores programing instructions executable by the one or more processors to perform operations comprising:
in response to the second user interaction, switching the second icon of the first interactive element to the first icon of the first interactive element.
